(19) United States
(12) Patent Application Publication
(10) Pub. No.: US 2025/0387198 A1
(43) Pub. Date: Dec. 25, 2025

(54) ORTHODONTIC DEVICES AND METHODS OF USE

(71) Applicant: Brius Technologies, Inc., Carrollton, TX (US)

(72) Inventors: Woojae Kim, Dallas, TX (US); Mahdi Moradi, Dallas, TX (US); Milad Motamedi, Dallas, TX (US); Seyed Mehdi Roein Peikar, Carrollton, TX (US); James Sylvester Wratten, Jr., Waterville, NY (US)

(21) Appl. No.: 18/878,512

(22) PCT Filed: Jun. 26, 2023
(86) PCT No.: PCT/US2023/069107

§ 371 Date: Dec. 23, 2024

Related U.S. Application Data
(60) Provisional application No. 63/366,967, filed on Jun. 24, 2022.
(60) Provisional application No. 63/381,358, filed on Oct. 28, 2022.

(51) Int. Cl. A61C 7/00

(52) U.S. Cl. CPC A61C 7/002

(57) ABSTRACT

Orthodontic devices for treating a patient's teeth and methods of orthodontically treating a patient's teeth are disclosed herein. According to some embodiments. the present technology includes an orthodontic appliance comprising a plurality of attachment portions each configured to secure to a tooth of a patient and at least one connector extending between at least two adjacent attachment portions. In various embodiments. an attachment portion can be configured to secure to a patient's tooth via a securing member carried by the tooth. A method of securing an appliance to a patient's teeth can comprise securing each attachment portion of a plurality of attachment portions to its respective securing member in an order, which can be based on a relative difficulty of securing each attachment portion as compared to the other attachment portions.

### CROSS-REFERENCE TO RELATED APPLICATION(S)

The present application claims the benefit of priority to U.S. Provisional Patent Application No. 63/366,967, filed Jun. 24, 2022, and U.S. Provisional Patent Application No. 63/381,358, filed Oct. 28, 2022, each of which is incorporated by reference herein in its entirety.

### TECHNICAL FIELD

The present technology relates to the field of orthodontics and, more particularly, to methods for securing orthodontic appliances to a patient's teeth.

### BACKGROUND

A common objective in orthodontics is to move a patient's teeth to positions where the teeth function optimally and aesthetically. To move the teeth, the orthodontist begins by obtaining multiple scans and/or impressions of the patient's teeth to determine a series of corrective paths between the initial positions of the teeth and the desired ending positions. The orthodontist then fits the patient to one of two main appliance types: braces or aligners.

Traditional braces consist of brackets and an archwire placed across a front side of the teeth, with elastic ties or ligature wires to secure the archwire to the brackets. In some cases self-ligating brackets may be used in lieu of ties or wires. The shape and stiffness of the archwire as well as the archwire-bracket interaction governs the forces applied to the teeth and thus the direction and degree of tooth movement. To exert a desired force on the teeth, the orthodontist often manually bends the archwire. The orthodontist monitors the patient's progress through regular appointments, during which the orthodontist visually assesses the progress of the treatment and makes manual adjustments to the archwire (such as new bends) and/or replaces or repositions brackets. The adjustment process is both time consuming and tedious for the patient and more often than not results in patient discomfort for several days following the appointment. Moreover, braces are not aesthetically pleasing and make brushing, flossing, and other dental hygiene procedures difficult.

Aligners comprise clear, removable, polymeric shells having cavities shaped to receive and reposition teeth to produce a final tooth arrangement. Aligners offer patients significantly improved aesthetics over braces. Aligners do not require the orthodontists to bend wires or reposition brackets and are generally more comfortable than braces. However, unlike braces, aligners cannot effectively treat all malocclusions. Certain tooth repositioning steps, such as extrusion, translation, and certain rotations, can be difficult or impossible to achieve with aligners. Moreover, because the aligners are removable, success of treatment is highly dependent on patient compliance, which can be unpredictable and inconsistent.

Lingual braces are an alternative to aligners and traditional (buccal) braces and have been gaining popularity in recent years. Two examples of existing lingual braces are the Incognito™ Appliance System (3M United States) and INBRACE® (Swift Health Systems, Irvine, California, USA), each of which consists of brackets and an archwire placed on the lingual, or tongue side, of the teeth. In contrast to traditional braces, lingual braces are virtually invisible, and, unlike aligners, lingual braces are fixed to the patient's teeth and force compliance. These existing lingual technologies, however, also come with several disadvantages. Most notably, conventional lingual appliances still rely on a bracket-archwire system to move the teeth, thus requiring multiple office visits and painful adjustments. For example, lingual technologies have a relatively short inter-bracket distance, which generally makes compliance of the archwire stiffer. As a result, the overall lingual appliance is more sensitive to archwire adjustments and causes more pain for the patient. Moreover, the lingual surfaces of the appliance can irritate the tongue and impact speech, and make the appliance difficult to clean.

Therefore, a need exists for improved orthodontic appliances.

### SUMMARY

Various embodiments of the present technology are directed orthodontic treatment of a patient's teeth. Some embodiments comprise orthodontic appliances for delivering orthodontic forces to a patient's teeth and/or methods of securing an orthodontic appliance to a patient's teeth. According to some embodiments, a method of securing an orthodontic appliance to a patient's teeth comprises securing attachment portions of the appliance to securing members carried by the patient's teeth in a specific, order. An order of securing the attachment portions to the securing members can, in various embodiments, be based on a relative difficulty of securing each attachment portion to a respective securing member. In some embodiments, a method of orthodontically treating a patient's teeth comprises securing an orthodontic appliance to a patient's teeth according to instructions that communicate an order for securing attachment portions of the appliance to respective securing members and/or other useful information such as, but not limited to, an amount of interproximal reduction to perform between adjacent teeth.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIGS. 1A and 1B schematically illustrate directional references relative to a patient's dentition.

FIG. 2A shows the schematic representation of an orthodontic appliance configured in accordance with the present technology installed in a patient's mouth adjacent the patient's dentition.

FIG. 2B is a schematic depiction of connection configuration options configured in accordance with embodiments of the present technology.

FIG. 2C is a schematic depiction of a portion of an appliance configured in accordance with embodiments of the present technology.

FIG. 2D is a schematic depiction of a portion of an appliance configured in accordance with embodiments of the present technology.

FIG. 2E is a schematic depiction of a portion of an appliance configured in accordance with embodiments of the present technology.

FIGS. 3A and 3B are elevation views of an appliance configured in accordance with several embodiments of the present technology installed in an upper and lower jaw of a patient's mouth with the patient's teeth in an original tooth arrangement and a final tooth arrangement, respectively.

FIG. 3C is a graph showing the stress-strain curves for nitinol and steel.

FIG. 4 is a flow chart of a method for determining an order for securing attachment portions of an appliance to a patient's teeth in accordance with embodiments of the present technology.

FIG. 5 illustrates an example of a movement of a tooth along an occlusogingival dimension and deformation that a connector connected the tooth will undergo during installation of an appliance in accordance with embodiments of the present technology.

FIG. 6 illustrates an example of a movement of a tooth along an occlusogingival dimension and deformation that a connector connected the tooth will undergo during installation of an appliance in accordance with embodiments of the present technology.

FIG. 7 illustrates an example of a movement of a tooth along a mesiodistal dimension and deformation that a connector connected the tooth will undergo during installation of an appliance in accordance with embodiments of the present technology.

FIG. 8 illustrates an example of a movement of a tooth along a mesiodistal dimension and deformation that a connector connected the tooth will undergo during installation of an appliance in accordance with embodiments of the present technology.

FIG. 9 illustrates an example of a movement of a tooth along a buccolingual dimension and deformation that a connector connected the tooth will undergo during installation of an appliance in accordance with embodiments of the present technology.

FIG. 10 illustrates an example of a movement of a tooth along a buccolingual dimension and deformation that a connector connected the tooth will undergo during installation of an appliance in accordance with embodiments of the present technology.

FIG. 11 illustrates deformation of a connector when a tooth is positioned at a variety of positions in which the tooth is lingual in an original arrangement of the teeth relative to a final arrangement of the teeth in accordance with embodiments of the present technology.

FIG. 12 illustrates example connectors in passive and deformed states in accordance with embodiments of the present technology.

FIG. 13 is a table summarizing the lengths and deformations of the connectors of FIG. 12.

FIGS. 14 and 15 depict an example formula for determining a difficulty parameter in accordance with embodiments of the present technology.

FIG. 16 depicts example calculations using the formula of FIGS. 14 and 15 to calculate difficulty parameters for specific tooth movements.

FIG. 17 depicts an example method of determining a securing order based on a plurality of difficulty parameters in accordance with embodiments of the present technology.

FIG. 18 illustrates compression and stretching of a connector in accordance with embodiments of the present technology.

FIG. 19 depicts an example formula for determining a difficulty parameter in accordance with embodiments of the present technology.

FIG. 20 is a flow chart of an example method for determining a securing order in accordance with embodiments of the present technology.

FIG. 21 is a flow chart of an example method for determining a securing order in accordance with embodiments of the present technology.

FIGS. 22 and 23 illustrate example movements of two teeth from an original arrangement to a final arrangement in which a distance between the teeth does not change in accordance with embodiments of the present technology.

FIGS. 24 and 25 illustrate example movements of two teeth from an original arrangement to a final arrangement in which a distance between the teeth does change in accordance with embodiments of the present technology.

FIG. 26 illustrates example movements of teeth along a mesiodistal dimension and deformation that connectors connected the teeth will undergo during installation of an appliance in accordance with embodiments of the present technology.

FIGS. 27 and 28 illustrate example movements of teeth along an occlusogingival dimension and deformation that connectors connected the teeth will undergo during installation of an appliance in accordance with embodiments of the present technology.

FIG. 29 depicts example instructions for orthodontically treating a patient's teeth in accordance with embodiments of the present technology.

FIG. 30 depicts example instructions for orthodontically treating a patient's teeth in accordance with embodiments of the present technology.

### DETAILED DESCRIPTION

### I. Definitions

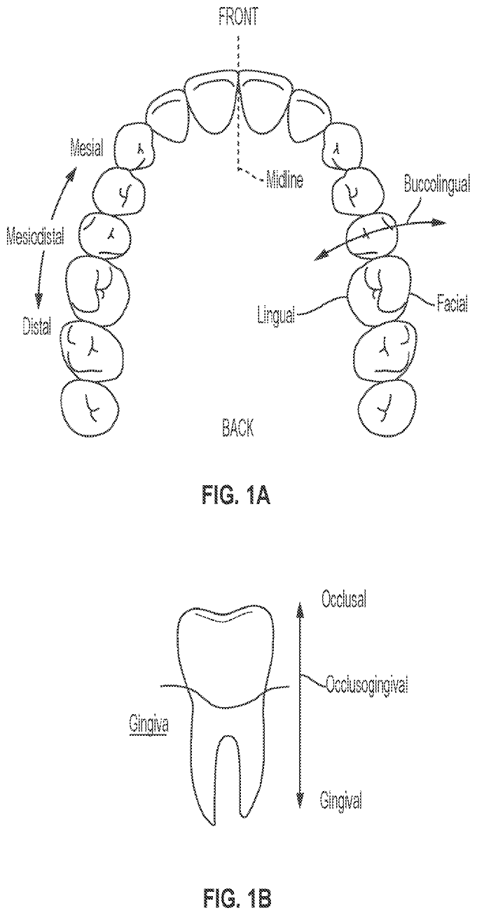

FIGS. 1A and 1B schematically depict several directional terms related to a patient's dentition. Terms used herein to provide anatomical direction or orientation are intended to encompass different orientations of the appliance as installed in the patient's mouth, regardless of whether the structure being described is shown installed in a mouth in the drawings. As illustrated in FIGS. 1A and 1B: “mesial” means in a direction toward the midline of the patient's face along the patient's curved dental arch; “distal” means in a direction away from the midline of the patient's face along the patient's curved dental arch; “occlusal” means in a direction toward the chewing surfaces of the patient's teeth; “gingival” means in a direction toward the patient's gums or gingiva; “facial” means in a direction toward the patient's lips or cheeks (used interchangeably herein with “buccal” and “labial”); and “lingual” means in a direction toward the patient's tongue.

As used herein, the terms “proximal” and “far” refer to a position that is closer and farther, respectively, from a given reference point. In many cases, the reference point is a certain connector, such as an anchor, and “proximal” and “far” refer to a position that is closer and farther, respectively, from the reference connector along a line passing through the centroid of the cross-section of the portion of the appliance branching from the reference connector.

As used herein, the terms “generally,” “substantially,” “about,” and similar terms are used as terms of approximation and not as terms of degree, and are intended to account for the inherent variations in measured or calculated values that would be recognized by those of ordinary skill in the art.

As used herein, the term “operator” refers to a clinician, practitioner, technician or any person or machine that designs and/or manufactures an orthodontic appliance or portion thereof, and/or facilitates the design and/or manufacture of the appliance or portion thereof, and/or any person or machine associated with installing the appliance in the patient's mouth and/or any subsequent treatment of the patient associated with the appliance.

As used herein, the term “force” refers to the magnitude and/or direction of a force, a torque, or a combination thereof.

### II. Overview of Orthodontic Appliances of the Present Technology

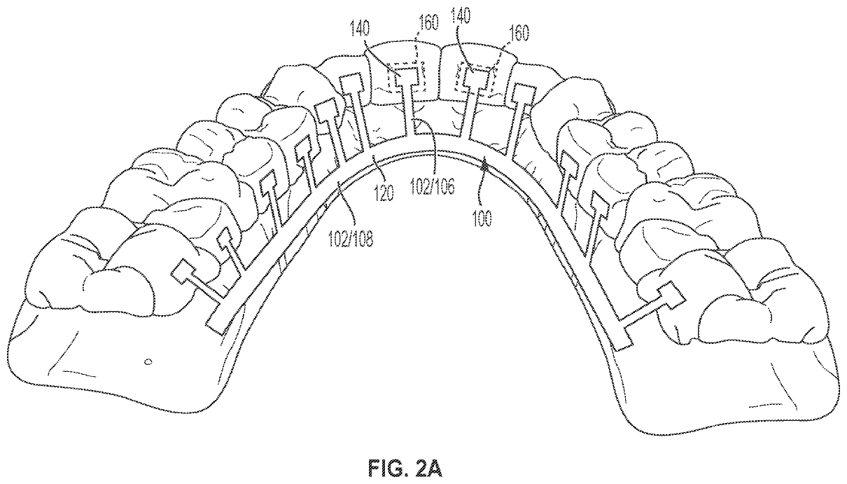

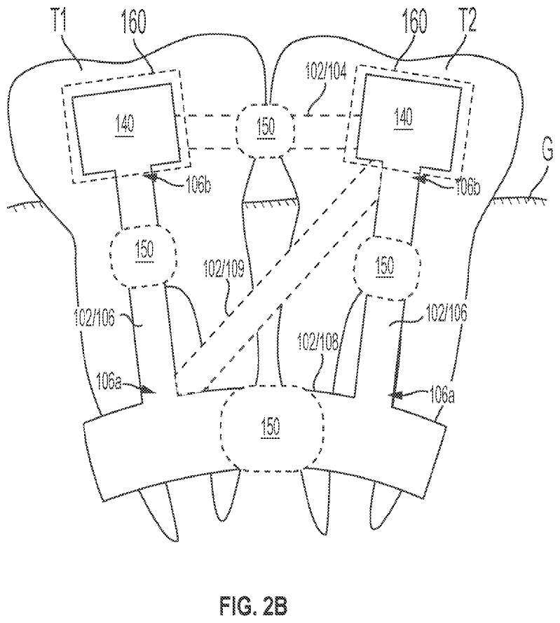

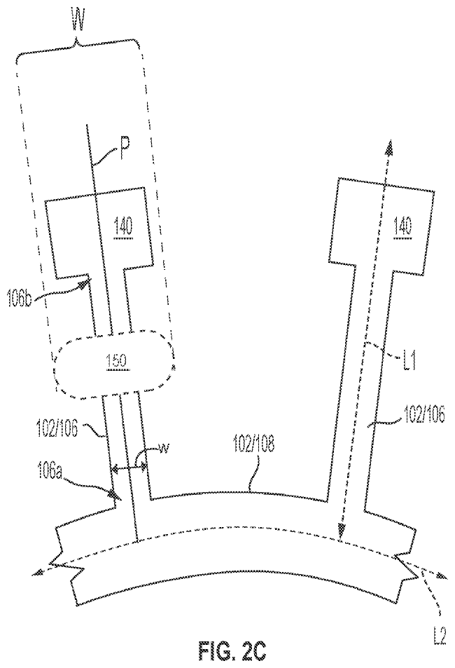

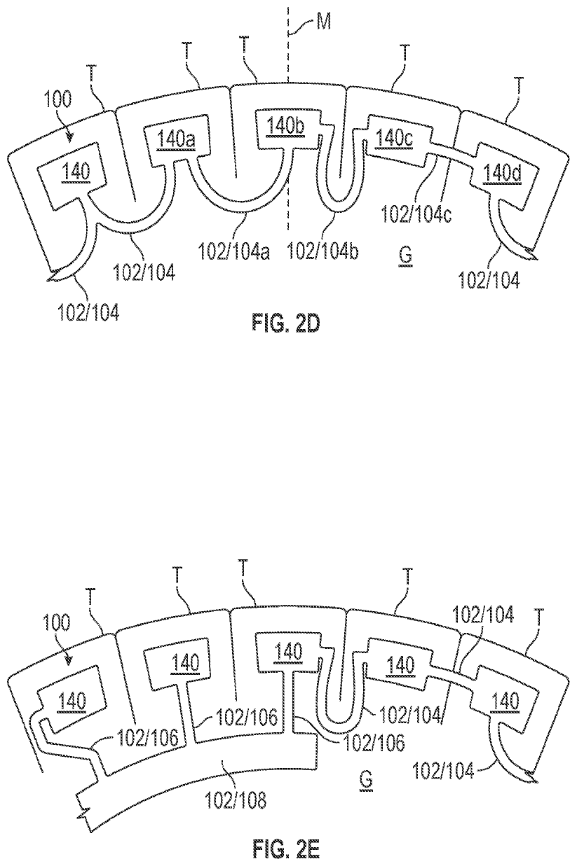

FIG. 2A is a schematic representation of an orthodontic appliance 100 (or “appliance 100”) configured in accordance with embodiments of the present technology, shown positioned in a patient's mouth adjacent the patient's teeth. FIG. 2B is an enlarged view of a portion of the appliance 100. The appliance 100 is configured to be installed within a patient's mouth to impart forces on one or more of the teeth to reposition all or some of the teeth. In some cases, the appliance 100 may additionally or alternatively be configured to maintain a position of one or more teeth. As shown schematically in FIGS. 2A and 2B, the appliance 100 can comprise a deformable member that includes one or more attachment portions 140 (each represented schematically by a box), each configured to be secured to a tooth surface directly or indirectly via a securing member 160. The appliance 100 may further comprise one or more connectors 102 (also depicted schematically), each extending directly between attachment portions 140 (“first connectors 104”), between an attachment portion 140 and one or more other connectors 102 (“second connectors 106”), or between two or more other connectors 102 (“third connectors 108”). Only two attachment portions 140 and two connectors 102 are labeled in FIG. 2A for ease of illustration. As discussed herein, the number, configuration, and location of the connectors 102 and attachment portions 140 may be selected to provide a desired force on one or more of the teeth when the appliance 100 is installed.

The attachment portions 140 may be configured to be detachably coupled to a securing member 160 that is bonded, adhered, or otherwise secured to a surface of one of the teeth to be moved. In some embodiments, one or more of the attachment portions 140 may be directly bonded, adhered, or otherwise secured to a corresponding tooth without a securing member or other connection interface at the tooth. The attachment portions 140 may also be referred to as “bracket connectors” or “male connector elements” herein. The different attachment portions 140 of a given appliance 100 may have the same or different shape, same or different size, and/or same or different configuration. The attachment portions 140 may comprise any one or combination of the attachment portions disclosed herein, any one of the bracket connectors and/or male connector elements disclosed herein, as well as any of the attachment portions, bracket connectors, and/or male connector elements disclosed in U.S. patent application Ser. No. 15/370,704 (Publ. No. 2017/0156823) filed Dec. 6, 2016, U.S. patent application Ser. No. 15/929,443 (Publ. No. 20201/0007830), and/or U.S. patent application Ser. No. 15/929,443 (Publ. No. 2020/0390524) each of which is incorporated by reference herein in its entirety.

The appliance 100 may include any number of attachment portions 140 suitable for securely attaching the appliance 100 to the patient's tooth or teeth in order to achieve a desired movement. In some examples, multiple attachment portions 140 may be attached to a single tooth. The appliance 100 may include an attachment portion for every tooth, fewer attachment portions than teeth, or more attachment portions 140 than teeth. In these and other embodiments, the one or more of the attachment portions 140 may be configured to be coupled to one, two, three, four, five or more connectors 102. Moreover, any of the first and second connectors 104, 106 can extend from any portion of a corresponding attachment portion 140. For example, one or both ends of a given first and/or second connector 104, 106 can be disposed at an occlusal, gingival, mesial, or distal side of a corresponding attachment portion 140. In some embodiments, a location at which a connector connects to an attachment portion is based at least in part on an amount of space in the patient's mouth, an intended force to be applied to a tooth, etc. For example, in some cases it may be challenging to connect a second connector 106 to a gingival portion of an attachment portion 140 that is configured to impart an intended torque on a tooth to which the attachment portion 140 is configured to be secured. Accordingly, it may be preferable for the second connector 106 to connect to a mesial portion or a distal portion of the attachment portion 140 in these embodiments and others. In some cases, it may be challenging to connect a first and/or second connector 104, 106 to a mesial or distal portion of an attachment portion 140 due to the space within a patient's mouth. For example, if connecting the connector to a mesial or distal portion of an attachment portion 140 would cause the connector to collide with an adjacent tooth during installation or treatment, it may be preferable to connect the connector to a gingival or an occlusal portion of the attachment portion 140 to prevent such collision.

As previously mentioned, the connectors 102 may comprise one or more first connectors 104 that extend directly between attachment portions 140. The one or more first connectors 104 may extend along a generally mesiodistal dimension when the appliance 100 is installed in the patient's mouth. In these and other embodiments, the appliance 100 may include one or more first connectors 104 that extend along a generally occlusogingival and/or buccolingual dimension when the appliance 100 is installed in the patient's mouth. According to several embodiments, a single first connector 104 can have one or more bends such that it extends at least two of mesiodistally, occlusogingivally, or buccolingually. FIG. 2D, for example, shows a first connector 104a that extends gingivally from a gingival side of a first attachment portion 140a then bends and extends occlusally until terminating at a gingival side of a second attachment portion 140b. First connector 104b extends distally (assuming a midline M) from a distal side of the second attachment portion 140b, then bends and extends gingivally, then bends and extends occlusally, then bends and extends distally until terminating at a mesial side of a third attachment portion 140c. First connector 104c extends distally from a distal side of the third attachment portion 140c to a mesial side of a fourth attachment portion 140d. It will be appreciated that many other first connector geometries are possible and that showing every possible first connector shape would not be feasible. In some embodiments, the appliance 100 does not include any first connectors 104.

In several embodiments, all of the attachment portions 140 of the appliance 100 are coupled to one another only by first connectors 104 (and no second or third connectors 106, 108) (also referred to as a “Z appliance” herein). FIG. 2D, for example, shows a portion of such a Z appliance 100. In these embodiments, some or all of the first connectors 104 can have the same geometry. In some of the Z appliances 100, some or all of the first connectors 104 can have a different geometry. For the sake of explanation, the portion of the appliance 100 shown in FIG. 2D includes a different first connector geometry between each pair of adjacent teeth T. While not labeled in FIG. 2D, one, some, or all of the first connectors 104 in a Z appliance 100 can have one or more biasing portions (described in greater detail below). One, some, or all of the first connectors 104 in a Z appliance 100 can be rigid. It may be advantageous for an appliance 100 to comprise only first connectors 104 if a patient has tori that would obstruct more gingivally positioned second or third connectors 106, 108, if space in a patient's mouth is limited, etc.

Additionally or alternatively, the connectors 102 may comprise one or more second connectors 106 that extend between one or more attachment portions 140 and one or more connectors 102. The one or more second connectors 106 can extend along a generally occlusogingival dimension when the appliance 100 is installed in the patient's mouth. In these and other embodiments, the appliance 100 may include one or more second connectors 106 that extend along a generally mesiodistal and/or buccolingual dimension when the appliance 100 is installed in the patient's mouth. In some embodiments, the appliance 100 does not include any second connectors 106. In such embodiments, the appliance 100 would only include first connectors 104 extending between attachment portions 140. The use of two or more connectors to connect two points on the appliance 100 enables application of a greater force (relative to a single connector connecting the same points) without increasing the strain on the individual connectors. Such a configuration is especially beneficial given the spatial constraints of the fixed displacement treatments herein.

Additionally or alternatively, the connectors 102 may comprise one or more third connectors 108 that extend between two or more other connectors 102. The one or more third connectors 108 may extend along a generally mesiodistal dimension when the appliance 100 is installed in the patient's mouth. In these and other embodiments, the appliance 100 may include one or more third connectors 108 that extend along a generally occlusogingival and/or buccolingual dimension when the appliance 100 is installed in the patient's mouth. In some embodiments, the appliance 100 does not include any third connectors 108. One, some, or all of the third connectors 108 may be positioned gingival to one, some, or all of the first connectors 104. In some embodiments, the appliance 100 includes a single third connector 108 that extends along at least two adjacent teeth and provides a common attachment for two or more second connectors 106. In several embodiments, the appliance 100 includes multiple non-contiguous third connectors 108, each extending along at least two adjacent teeth.

In several embodiments, all of the attachment portions 140 of the appliance 100 are coupled to one another only by second and third connectors 106, 108 (and no first connectors 104) (also referred to as an “X appliance” herein). FIG. 2A, for example, shows such an X appliance 100. In these embodiments, and others, some or all of the second connectors 106 can have the same geometry. In some of the X appliances 100, some or all of the second connectors 106 can have a different geometry. While not labeled in FIG. 2A, one, some, or all of the second connectors 106 in an X appliance 100 can have one or more biasing portions. One, some, or all of the second connectors 106 in an X appliance 100 can be rigid.

In several embodiments, the appliance 100 comprises two or more attachment portions 140 that are coupled to one another by first connectors 104 and two or more attachment portions 140 coupled to one another by second and third connectors 106, 108. In some embodiments, the appliance 100 comprises two or more attachment portions 140 that are coupled to one another by first connectors 104 (and no second or third connectors 106, 108) and two or more attachment portions 140 coupled to one another by second and third connectors 106, 108 (and no first connectors 104). The foregoing hybrid appliances are referred to herein as “XZ appliances.” FIG. 2E, for example, shows a portion of such an XZ appliance 100. In these embodiments, and others, some or all of the first connectors 104 can have the same geometry. In some of the XZ appliances 100, some or all of the first connectors 104 can have a different geometry. While not labeled in FIG. 2E, one, some, or all of the first connectors 104 in an XZ appliance 100 can have one or more biasing portions. One, some, or all of the first connectors 104 in an XZ appliance 100 can be rigid. In an XZ appliance 100, some or all of the second connectors 106 can have the same geometry. In some of the XZ appliances 100, some or all of the second connectors 106 can have a different geometry. While not labeled in FIG. 2F, one, some, or all of the second connectors 106 in an XZ appliance 100 can have one or more biasing portions. One, some, or all of the second connectors 106 in an XZ appliance 100 can be rigid. Although FIG. 2E depicts the third connector 108 mesiodistally adjacent to the first connectors 104, in some XZ appliances 100 one or more first connectors 104 can be mesiodistally aligned with one or more third connectors 108.

As shown in FIG. 2A, in some embodiments the appliance 100 may be configured such that all or a portion of one, some, or all of the connectors 102 are disposed proximate the patient's gingiva when the appliance 100 is installed within the patient's mouth. For example, one or more third connectors 108 may be configured such that all or a portion of the one or more third connectors 108 is positioned below the patient's gum line and adjacent to but spaced apart from the gingiva. In many cases it may be beneficial to provide a small gap (e.g., 0.5 mm or less) between the third connector(s) 108 and the patient's gingiva, as contact between the third connector(s) 108 (or any portion of the appliance 100) and the gingiva can cause irritation and patient discomfort. In some embodiments, all or a portion of the third connector(s) 108 is configured to be in direct contact with the gingiva when the appliance 100 is disposed in the patient's mouth. Additionally or alternatively, all or a portion of one or more first connectors 104 and/or second connectors 106 may be configured to be disposed proximate the gingiva.

According to some embodiments, one or more connectors 102 may extend between an attachment portion 140 or connector 102 and a joint comprising (a) two or more connectors 102, (b) two or more attachment portions 140, or (c) at least one attachment portion 140 and at least one connector 102. According to some embodiments, one or more connectors 102 may extend between a first joint comprising (a) two or more connectors 102, (b) two or more attachment portions 140, or (c) at least one attachment member and at least one connector 102, and a second joint comprising (a) two or more connectors 102, (b) two or more attachment portions 140, or (c) at least one attachment portion 140 and at least one connector 102. An example of a connector 102 extending between (a) a joint between a second and third connector 106, 108, and (b) a joint between a second connector 106 and an attachment portion 140 is depicted schematically and labeled 109 in FIG. 2B.

Each of the connectors 102 may be designed to have a desired stiffness so that an individual connector 102 or combination of connectors 102 imparts a desired force on one or more of the teeth. In many cases, the force applied by a given connector 102 may be governed by Hooke's Law, or F=k×x, where F is the restoring force exerted by the connector 102, k is the stiffness coefficient of the connector 102, and x is the displacement. In the most basic example, if a connector 102 does not exist between two points on the appliance 100, then the stiffness coefficient along that path is zero and no forces are applied. In the present case, the individual connectors 102 of the present technology may have varying non-zero stiffness coefficients. For example, one or more of the connectors 102 may be rigid (i.e., the stiffness coefficient is infinite) such that the connector 102 will not flex or bend between its two end points. In some embodiments, one or more of the connectors 102 may be “flexible” (i.e., the stiffness coefficient is non-zero and positive) such that the connector 102 can deform to impart (or absorb) a force on the associated tooth or teeth or other connector 102.

In some embodiments it may be beneficial to include one or more rigid connectors between two or more teeth. A rigid connector 102 is sometimes referred to herein as a “rigid bar” or an “anchor.” Each rigid connector 102 may have sufficient rigidity to hold and maintain its shape and resist bending. The rigidity of the connector 102 can be achieved by selecting a particular shape, width, length, thickness, and/or material. Connectors 102 configured to be relatively rigid may be employed, for example, when the tooth to be connected to the connector 102 is not to be moved (or moved by a limited amount) and can be used for anchorage. Molar teeth, for example, can provide good anchorage as molar teeth have larger roots than most teeth and thus require greater forces to be moved. Moreover, anchoring one or more portions of the appliance 100 to multiple teeth is more secure than anchoring to a single tooth. As another example, a rigid connection may be desired when moving a group of teeth relative to one or more other teeth. Consider, for instance, a case in which the patient has five teeth separated from a single tooth by a gap, and the treatment plan is to close the gap. The best course of treatment is typically to move the one tooth towards the five teeth, and not vice versa. In this case, it may be beneficial to provide one or more rigid connectors between the five teeth. For all of the foregoing reasons and many others, the appliance 100 may include one or more rigid first connectors 104, one or more rigid second connectors 106, and/or one or more rigid third connectors 108.

In these and other embodiments, the appliance 100 may include one or more flexible first connectors 104, one or more flexible second connectors 106, and/or one or more flexible third connectors 108. Each flexible connector 102 may have a particular shape, width, thickness, length, material, and/or other parameters to provide a desired degree of flexibility. According to some embodiments of the present technology, the stiffness of a given connector 102 may be tuned via incorporation of a one or more resiliently flexible biasing portions 150. As shown schematically in FIG. 2B, one, some, or all of the connectors 102 may include one or more biasing portion 150, such as springs, each configured to apply a customized force, torque or combination of force and torque specific to the tooth to which it is attached.

As depicted in the schematic shown in FIG. 2C, the biasing portion(s) 150 may extend along all or a portion of the longitudinal axis L1 of the respective connector 102 (only the longitudinal axis L1 for second connector 106 and the longitudinal axis L2 for third connector 108 is labeled in FIG. 2C). The direction and magnitude of the force and torque applied on a tooth by a biasing portion 150 depends, at least in part, on the shape, width, thickness, length, material, shape set conditions (e.g., austenite transformation finish temperature, etc.), and other parameters of the biasing portion 150. As such, one or more aspects of the biasing portion 150 (including the aforementioned parameters) may be varied so that the connector 102 and/or biasing portion 150 produces a desired tooth movement when the appliance 100 is installed in the patient's mouth. Each connector 102 and/or biasing portion 150 may be designed to move one or more teeth in one, two, or all three translational directions (i.e., mesiodistal, buccolingual, and occlusogingival) and/or in one, two, or all three rotational directions (i.e., buccolingual root torque, mesiodistal angulation and mesial out-in rotation).

The biasing portions 150 of the present technology can have any length, width, shape, and/or size sufficient to move the respective tooth towards a desired position. In some embodiments, one, some, or all of the connectors 102 may have one or more inflection points along a respective biasing portion 150. The connectors 102 and/or biasing portions 150 may have a serpentine configuration such that the connector 102 and/or biasing portion 150 doubles back on itself at least one or more times before extending towards the attachment portion 140. For example, in some embodiments the second connectors 106 double back on themselves two times along the biasing portion 150, thereby forming first and second concave regions facing in generally different directions relative to one another. The open loops or overlapping portions of the connector 102 corresponding to the biasing portion 150 may be disposed on either side of a plane P (FIG. 2C) bisecting an overall width W (FIG. 2C) of the connector 102 such that the extra length of the connector 102 is accommodated by the space medial and/or distal to the connector 102. This allows the connector 102 to have a longer length (as compared to a linear arm) to accommodate greater tooth movement, despite the limited space in the occlusal-gingival or vertical dimension between any associated third connector 108 and the location at which the connector 102 attaches to the tooth.

It will be appreciated that the biasing portion 150 may have other shapes or configurations. For example, in some embodiments the connector 102 and/or biasing portion 150 may include one or more linear regions that zig-zag towards the attachment portion 140. One, some, or all of the connectors 102 and/or biasing portions 150 may have only linear segments or regions, or may have a combination of curved and linear regions. In some embodiments, one, some, or all of the connectors 102 and/or biasing portions 150 do not include any curved portions.

According to some examples, a single connector 102 may have multiple biasing portions 150 in series along the longitudinal axis of the respective connector 102. In some embodiments, multiple connectors 102 may extend between two points along the same or different paths. In such embodiments, the different connectors 102 may have the same stiffness or different stiffnesses.

In those embodiments where the appliance 100 has two or more connectors 102 with biasing portions 150, some, none, or all of the connectors 102 may have the same or different lengths, the same or different widths, the same or different thicknesses, the same or different shapes, and/or may be made of the same or different materials, amongst other properties. In some embodiments, less than all of the connectors 102 have biasing portions 150. Connectors 102 without biasing portions 150 may, for example, comprise one or more rigid connections between a rigid third connector 108 and the attachment portion 140. In some embodiments, none of the connectors 102 of the appliance 100 have a biasing portion 150.

According to some embodiments, for example as depicted schematically in FIG. 2A, the appliance 100 may include a continuous, substantially rigid third connector (referred to as “anchor 120”) and a plurality of flexible second connectors 106 extending away from the anchor 120. When the appliance 100 is installed in the patient's mouth, each of the second connectors 106 may connect to a different one of the teeth to be moved and exerts a specific force on its respective tooth, thereby allowing an operator to move each tooth independently. Such a configuration provides a notable improvement over traditional braces in which all of the teeth are connected by a single archwire, such that movement of one tooth can cause unintentional movement of one or more nearby teeth. As discussed in greater detail herein, the independent and customized tooth movement enabled by the appliances of the present technology allows the operator to move the teeth from an original tooth arrangement (“OTA”) to a final tooth arrangement (“FTA”) more efficiently, thereby obviating periodic adjustments, reducing the number of office visits, and reducing or eliminating patient discomfort, and reducing the overall treatment time (i.e., the length of time the appliance is installed in the patient's mouth) by at least 50% relative to the overall treatment time for traditional braces.

The anchor 120 may comprise any structure of any shape and size configured to comfortably fit within the patient's mouth and provide a common support for one or more of the second connectors 106. In many embodiments, the anchor 120 is disposed proximate the patient's gingiva when the appliance 100 is installed within the patient's mouth, for example as shown in FIG. 2A. For instance, the appliance may be designed such that, when installed in the patient's mouth, all or a portion of the anchor 120 is positioned below the patient's gum line and adjacent but spaced apart from the gingiva. In many cases it may be beneficial to provide a small gap (e.g., 0.5 mm or less) between the anchor 120 (or any portion of the appliance 100) and the patient's gingiva as contact between the anchor 120 and the gingiva can cause irritation and patient discomfort. In some embodiments, all or a portion of the anchor 120 is configured to be in contact with the gingiva when the appliance 100 is disposed in the patient's mouth.

The anchor 120 may be significantly more rigid than the second connectors 106 such that the equal and opposite forces experienced by each of the second connectors 106 when exerting a force on its respective tooth are countered by the rigidity of the anchor 120 and the forces applied by the other second connectors 106, and do not meaningfully affect the forces on other teeth. As such, the anchor 120 effectively isolates the forces experienced by each second connectors 106 from the rest of the second connectors 106, thereby enabling independent tooth movement. Because the anchor 120 is more rigid than the second connectors 106, any reaction forces applied to the anchor 120 by a connector 106 can be approximately evenly distributed among other teeth connected to the anchor 120 via second connectors 106 such that the reaction force applied to each of the other teeth is below a threshold required to cause movement of the other tooth. In this manner, movement of one tooth caused by a second connector 106 applying force to the tooth may not cause movement of the patient's other teeth.

According to some embodiments, for example as shown schematically in FIG. 2A and 2B, the anchor 120 comprises an elongated member having a longitudinal axis L2 (see FIG. 2C) and forming an arched shape configured to extend along a patient's jaw when the appliance 100 is installed. In these and other embodiments, the anchor 120 may be shaped and sized to span two or more of the patient's teeth when positioned in the patient's mouth. In some examples, the anchor 120 includes a rigid, linear bar, or may comprise a structure having both linear and curved segments. In these and other embodiments, the anchor 120 may extend laterally across all or a portion of the patient's mouth (e.g., across all or a portion of the palate, across all or a portion of the lower jaw, etc.) and/or in a generally anterior-posterior direction. Moreover, the appliance 100 may comprise a single anchor or multiple anchors. For example, the appliance 100 may comprise multiple, discrete, spaced apart anchors, each having one or more second connectors 106 extending therefrom. In these and other embodiments, the appliance 100 may include one or more other connectors extending between adjacent second connectors 106. In various embodiments, the anchor 120 (or any of the connectors 102 disclosed herein) can define an opening configured to receive a temporary anchorage device or other orthodontic device therein. Additionally or alternatively, the anchor 120 (or any of the connectors 102 disclosed herein) can include a securing element such as a hook, a button, a clip, etc. for securing an orthodontic device (e.g., an elastic, a temporary anchorage device, etc.) to the appliance 100.

Any and all of the features discussed above with respect to anchor 120 applies to any of the third connectors 108 disclosed herein.

As shown in FIG. 2C, each of the second connectors 106 may extend between a first end portion 106a and a second end portion 106b, and may have a longitudinal axis L1 extending between the first end portion 106a and the second end portion 106b. The first end portion 106a of one, some, or all of the second connectors 106 may be disposed at the third connector 108 and/or anchor 120. In some embodiments, one, some, or all of the second connectors 106 are integral with the third connector 108 and/or anchor 120 such that the first end portion 106a of such second connectors 106 are continuous with the third connector 108 and/or anchor 120. The second connectors 106 may extend from the third connector 108 and/or anchor 120 at spaced intervals along the longitudinal axis L2 of the third connector 108 and/or anchor 120, as shown in FIGS. 2A and 2C. In some embodiments, the second connectors 106 may be spaced at even intervals relative to each other, or at uneven intervals relative to each other, along the longitudinal axis L2 of the third connector 108 and/or anchor 120.

One, some, or all of the second connectors 106 may include and/or be coupled to an attachment portion 140 at or near the second end portion 106b of the respective second connector 106. In some embodiments, for example as shown in FIGS. 2A-2C, one or more of the second connectors 106 is cantilevered from the third connector 108 and/or anchor 120 such that the second end portion 106b of the cantilevered second connector(s) 106 has a free second end portion 106b. In these and other embodiments, a gingival terminus of the attachment portion 140 may coincide with an occlusal terminus of the second connector 106. In some embodiments, the second connector 106 can connect to a mesial portion, a distal portion, and/or an occlusal portion of the attachment portion 140. The attachment portion 140 may be configured to detachably couple the respective second connector 106 to a securing member (e.g., a bracket) that is bonded, adhered, or otherwise secured to a surface of one of the teeth to be moved. In some embodiments, the attachment portion 140 may be directly bonded, adhered, or otherwise secured to a corresponding tooth without a securing member or other connection interface at the tooth. For example, the attachment portion 140 can comprise and/or can be secured to a polymeric cap having an inner surface with a contour substantially conforming to a surface of a tooth of the patient.

The appliances of the present technology may include any number of connectors 102 suitable for repositioning the patient's teeth while taking into account the patient's comfort. Unless explicitly limited to a certain number of connectors 102 in the specification, the appliances of the present technology may comprise a single connector 102, two connectors 102, three connectors 102, five connectors 102, ten connectors 102, sixteen connectors 102, etc. In some examples, one, some, or all of the connectors 102 of the appliance may be configured to individually connect to more than one tooth (i.e., a single connector 102 may be configured to couple to two teeth at the same time). In these and other embodiments, the appliance 100 may include two or more connectors 102 configured to connect to the same tooth at the same time.

Any portion of the appliances of the present technology may include a biasing portion 150. For example, in some embodiments, portion thereof (e.g., the anchor(s), the connector(s), the biasing portion(s), the attachment portion(s), the link(s), etc.) may comprise one or more superelastic materials.

Additional details related to the individual directional force(s) applied via the biasing portion 150 or, more generally the connectors 102, are described in U.S. application Ser. No. 15/370,704, now U.S. Pat. No. 10,383,707, issued Aug. 20, 2019, the disclosure of which is incorporated by reference herein in its entirety.

The appliances disclosed herein and/or any portion thereof (e.g., the anchor(s), the connector(s), the biasing portion(s), the attachment portion(s), the link(s), etc.) may comprise one or more superelastic materials. The appliances disclosed herein and/or any portion thereof (e.g., the anchor(s), the connector(s), the biasing portion(s), the attachment portion(s), the link(s), etc.) may comprise Nitinol, stainless steel, beta-titanium, cobalt chrome, MP35N, 35N LT, one or more metal alloys, one or more polymers, one or more ceramics, and/or combinations thereof.

The present technology includes a system comprising multiple appliances 100 for installation along a single arch. For example, the system can comprise a first appliance configured to be secured to at least two of the teeth of the arch and a second appliance configured to be secured to at least two different teeth of the same arch. The system can also comprise a third appliance, a fourth appliance, etc. The first appliance can be an X appliance, a Z appliance, or an XZ appliance. The second appliance can be an X appliance, a Z appliance, or an XZ appliance.

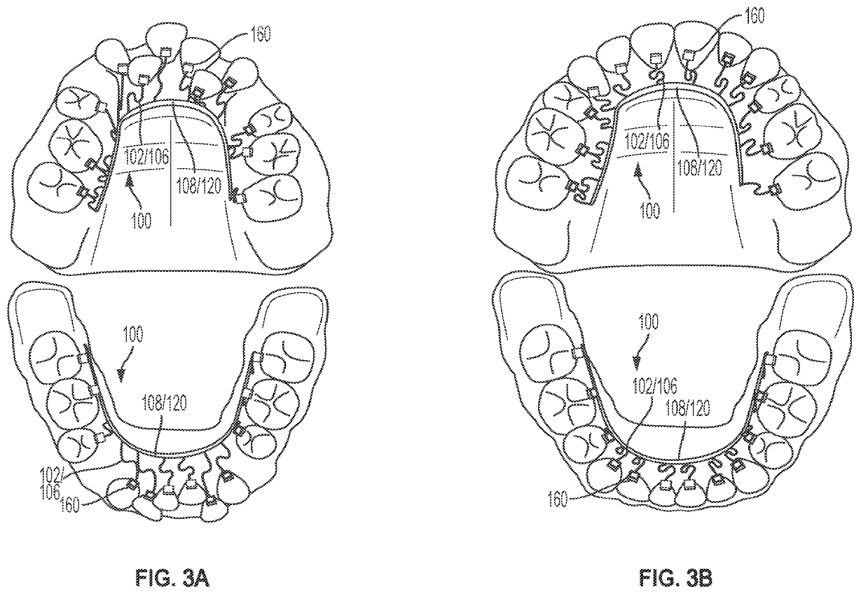

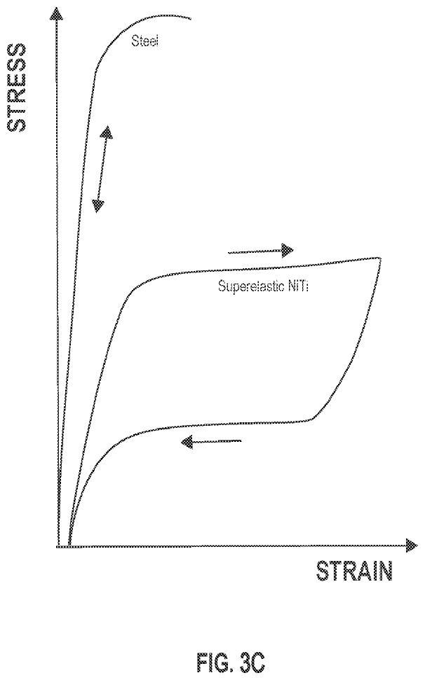

FIGS. 3A and 3B are elevation views of the appliance 100 installed on both the upper and lower arches of a patient's mouth with the connectors 102 coupled to securing members 160 attached to the lingual surfaces of the teeth via attachment portions 140. It will be appreciated that the appliance 100 of one or both of the upper and lower arches may be positioned proximate a buccal side of a patient's teeth, and that the securing members 160 and/or attachment portions 140 may alternatively be coupled to the buccal surface of the teeth.

FIG. 3A shows the teeth in an OTA with the connectors 102 in a deformed or loaded state, and FIG. 3B shows the teeth in the FTA with the connectors 102 in a substantially unloaded state. When the attachment portions 140 are initially secured to the securing members 160 when the teeth are in the OTA, the connectors 102 are forced to take a shape or path different than their “as designed” configurations. Because of the inherent memory of the resilient biasing portions 150, the connectors 102 impart a continuous, corrective force on the teeth to move the teeth towards the FTA, which is where the biasing portions 150 are in their as-designed or unloaded configurations. As such, tooth repositioning using the appliances of the present technology can be accomplished in a single step, using a single appliance. In addition to enabling fewer office visits and a shorter treatment time, the appliances of the present technology greatly reduce or eliminate the pain experienced by the patient as the result of the teeth moving as compared to braces. With traditional braces, every time the orthodontist makes an adjustment (such as installing a new archwire, bending the existing archwire, repositioning a bracket, etc.), the affected teeth experience a high force which is very painful for the patient. Over time, the applied force weakens until eventually a new wire is required. The appliances of the present technology, however, apply a movement-generating force on the teeth continuously while the appliance is installed, which allows the teeth to move at a slower rate that is much less painful (if painful at all) for the patient. Even though the appliances disclosed herein apply a lower and less painful force to the teeth, because the forces being applied are continuous and the teeth can move independently (and thus more efficiently), the appliances of the present technology arrive at the FTA faster than traditional braces or aligners, as both alternatives require intermediate adjustments.

In many embodiments, the movement-generating force is lower than that applied by traditional braces. In those embodiments in which the appliance comprises a superelastic material (such as nitinol), the superelastic material can behave like a constant force spring for certain ranges of strain such that the force applied does not drop appreciably as the tooth moves. For example, as shown in the stress-strain curves of nitinol and steel in FIG. 3C, the curve for nitinol is relatively flat compared to that of steel. Thus, the superelastic connectors and/or biasing portions of the present technology apply essentially the same stress for many different levels of strain (e.g., deflection). As a result, the force applied to a given tooth stays constant as the teeth move during treatment, at least up until the teeth are very close or in the final arrangement. The appliances of the present technology are configured to apply specific forces to a patient's teeth that move the teeth efficiently (e.g., quickly) but without causing adverse effects such as root resorption, pain, etc. For example, the appliances of the present technology can be configured to apply a force just below the pain threshold, such that the appliance applies the maximum non- painful force to the tooth (or teeth) at all or at least most times during tooth movement. This results in the most efficient (i.e., fastest) tooth movement without pain.

In some embodiments, tooth repositioning may involve multiple steps performed progressively, by using multiple appliances. Embodiments involving multiple steps (or multiple appliances, or both) may include one or more intermediate tooth arrangements (ITAs) between an original tooth arrangement (OTA) and a desired final tooth arrangement (FTA). Likewise, the appliances disclosed herein may be designed to be installed after a first or subsequently used appliance had moved the teeth from an OTA to an ITA (or from one ITA to another ITA) and was subsequently removed. Thus, the appliances of the present technology may be designed to move the teeth from an ITA to an FTA (or to another ITA). Additionally or alternatively, the appliances may be designed to move the teeth from an OTA to an ITA, or from an OTA to an FTA without changing appliances at an ITA.

In some embodiments, the appliances disclosed herein may be configured such that, once installed on the patient's teeth, the appliance cannot be removed by the patient. In some embodiments, the appliance may be removable by the patient.

Any of the example appliances or appliance portions described herein may be made of any suitable material or materials, such as, but not limited to Nitinol (NiTi), stainless steel, beta-titanium, cobalt chrome or other metal alloy, polymers or ceramics, and may be made as a single, monolithic structure or, alternatively, in multiple separately-formed components connected together in single structure. However, in particular examples, the rigid bars, bracket connectors and loop or curved features of an appliance (or portion of an appliance) described in those examples are made by cutting a two dimensional (2D) form of the appliance from a 2D sheet of material and bending the 2D form into a desired 3D shape of the appliance, according to processes as described in U.S. patent application Ser. No. 15/370,704 (Publ. No. 2017/0156823), filed Dec. 6, 2016, or other suitable processes.

### Methods of Manufacturing

The present technology includes methods for designing and fabricating an orthodontic appliance as described herein. The particular processes described herein are exemplary only, and may be modified as appropriate to achieve the desired outcome (e.g., the desired force applied to each tooth by the appliance, the desired material properties of the appliance, etc.). In various embodiments, other suitable methods or techniques can be utilized to fabricate an orthodontic appliance. Moreover, although various aspects of the methods disclosed herein refer to sequences of steps, in various embodiments the steps can be performed in different orders, two or more steps can be combined together, certain steps may be omitted, and additional steps not expressly discussed can be included in the process as desired.

As noted above, in some embodiments an orthodontic appliance is configured to be coupled to a patient's teeth while the teeth are in an OTA. In this position, elements of the appliance exert customized loads on individual teeth to urge them toward a desired FTA. For example, a connector 102 of the appliance 100 can be coupled to a tooth via an attachment portion 140 and configured to apply a force so as to urge the tooth in a desired direction toward the FTA. In one example, a connector 102 of the appliance 100 can be configured to apply a tensile force that urges the tooth lingually along the facial-lingual axis. By selecting the appropriate dimensions, shape, shape set, material properties, and other aspects of the connectors 102, a customized load can be applied to each tooth to move each tooth from its OTA toward its FTA. In some embodiments, the connectors 102 are each configured such that little or no force is applied once the tooth to which the connector 102 is coupled has achieved its FTA. In other words, the appliance 100 can be configured such that the connectors 102 are at rest and passive in the FTA state.

The method may begin with obtaining data (e.g., position data) characterizing the patient's OTA. In some embodiments the operator may obtain a digital representation of the patient's OTA, for example using optical scanning, cone beam computed tomography (CBCT), MRI, scanning of patient impressions, or other suitable imaging technique to obtain position data of the patient's teeth, gingiva, and optionally other adjacent anatomical structures while the patient's teeth are in the original or pre-treatment condition.

The method may further comprise obtaining data (e.g., position data) characterizing the patient's intended or desired FTA, and in many cases generating a digital representation of the patient's FTA. The data characterizing the FTA can include coordinates (e.g., X, Y, Z coordinates) for each of the patient's teeth and the gingiva. Additionally or alternatively, such data can include positioning of each of the patient's teeth relative to other ones of the patient's teeth and/or the gingiva.

In some embodiments, segmentation software can be used to create individual virtual teeth and gingiva from the OTA data. Suitable software can be used to move the virtual teeth to their FTA positions. In some cases, digital models of securing members can be added to the OTA digital model (e.g., by an operator selecting positions on the tooth surface for placement of securing members thereon). Suitable software can be used to move the virtual teeth with the attached securing members from the OTA to a desired final position. Additionally or alternatively, digital models of the securing members can be added to FTA digital models.

In some embodiments a heat treatment fixture digital model can be obtained. In some embodiments, the heat treatment fixture digital model can correspond to and/or be derived from the FTA digital model. For example, the FTA digital model can be modified in a variety of ways to render a model suitable for manufacturing a heat treatment fixture. In some embodiments, the FTA digital model can be modified to replace the securing members (which are configured to couple to attachment portions 140 of an appliance 100 (FIG. 2A)) with members (which can be configured to facilitate temporary coupling of the heat treatment fixture to the appliance for shape-setting). Additionally or alternatively, the FTA digital model can be modified to enlarge or thicken the gingiva, to remove one or more of the teeth, and/or to add structural components for increased rigidity. In some embodiments, enlarging or thickening the gingiva may be done to ensure portions (e.g., the anchor) of the fabricated appliance, which is based in part on the FTA digital model, does not engage or contact the patient's gingiva when the appliance is installed. As a result, modifying the FTA digital model as described herein may be done to provide a less painful teeth repositioning experience for the patient.

The method may further comprise obtaining an appliance digital model. As used herein, the term “digital model” and “model” are intended to refer to a virtual representation of an object or collection of objects. For example, the term “appliance digital model” refers to the virtual representation of the structure and geometry of the appliance, including its individual components (e.g., the connectors, biasing portions, attachment portions, etc.). In some embodiments, a substantially planar digital model of the appliance is generated based at least in part on the heat treatment fixture digital model (and/or the FTA digital model). According to some examples, a contoured or 3D appliance digital model generally corresponding to the FTA can first be generated that conforms to the surface and attachment features of the heat treatment fixture digital model. In some embodiments, the 3D appliance digital model can include generic connector portions and securing members, without particular geometries, dimensions, or other properties of the connectors being selected or defined by a particular patient. The 3D appliance digital model may then be flattened to generate a substantially planar appliance digital model. In some embodiments, the particular configuration of the connectors (e.g., the geometry of biasing portions 150, the position along the anchor 120 (FIG. 2A), etc.) can then be selected so as to apply the desired force to urge the corresponding tooth (to which the connector is attached) from its OTA toward its FTA. As noted previously, in some embodiments the connectors are configured so as to be substantially at rest or in a substantially unstressed state when at the FTA. The selected connector configurations can then be substituted or otherwise incorporated into the planar appliance digital model.

In some cases, it may be beneficial to evaluate an intended appliance design prior to fabricating a physical appliance based on the intended appliance design to assess how the physical appliance would perform during treatment. For example, because the pre-installation form of the appliance is based at least in part on a desired FTA, the position of one or more portions of the appliance may shift relative to the gingiva once the physical appliance is installed in the patient's mouth (e.g., with the patient's teeth in the OTA). As a result, one or more shifted positions of the physical appliance may cause pain for the patient that may reduce treatment compliance and/or satisfaction.

In some embodiments, finite element analysis (or other suitable computational techniques) can be used to manipulate the 3D appliance digital model to assess its performance prior to fabrication. For example, the 3D appliance digital model can be virtually deformed (e.g., using finite element analysis) into a position for engagement with the patient's teeth in the OTA. The resulting virtual model represents the appliance digital model after it has been deformed into position to be engaged with the patient's teeth in the OTA. An output of the virtual deformation can be evaluated to assess whether the physical appliance will function as intended. Based on the evaluation of the output, the intended appliance design can be modified as needed, or a final appliance design can be obtained. In some embodiments, a portion of the appliance digital model may impinge on the gingiva digital model. As a result, the design of the appliance may be modified, and the evaluation may be repeated until the appliance digital model no longer impinges on the gingiva. This process may be repeated iteratively until a satisfactory appliance design is achieved.

Next, the heat treatment fixture can be fabricated. For example, using the heat treatment fixture digital model, the heat treatment fixture can be cast, molded, 3D printed, or otherwise fabricated using suitable materials configured to withstand heating for shape setting of an appliance thereon.

In some embodiments, fabricating the appliance includes first fabricating the appliance in a planar configuration based on the planar appliance digital model. For example, a pattern of the planar form of the final device can be cut out of a sheet of material to get a planar member. In some embodiments, the appliance is cut out of a sheet of Nitinol or other metal using laser cutting, water jet, stamping, or other suitable technique. The thickness of the material can be varied across the appliance, for example by electropolishing, etching, depositing, or otherwise manipulating the material of the appliance to achieve the desired material properties

According to some embodiments, the planar member (e.g., as 3D-printed or as cut out from a sheet of material) can be bent or otherwise manipulated into the desired arrangement (e.g., substantially corresponding to the FTA) to form a 3D appliance for treatment. In some embodiments, the planar member can be bent into position by coupling the planar member to a heat treatment fixture. The heat treatment fixture may be, for example, the physical form of the previously-obtained heat treatment fixture digital model. For example, the attachment portions of the planar member can be removably coupled to hook members of the heat treatment fixture, and optionally ligature wire or other temporary fasteners can be used to secure the attachment portions or other portions of the appliance to the heat treatment fixture. The resulting assembly (i.e., the appliance fastened to the heat treatment fixture) can then be heated to shape-set the appliance into its final form, which can correspond or substantially correspond to the FTA. As a result, the appliance is configured to be in an unstressed state in the FTA. The shape set appliance can then be removed from the heat treatment fixture.

In operation, the appliance can then be installed in the patient's mouth (e.g., by bending or otherwise manipulating connectors of the appliance to couple the respective attachment portions to brackets of the patient's teeth while in the OTA). Due to the shape set of the appliance and the geometry of the connectors, the connectors will tend to urge each tooth away from its OTA and toward the FTA

### III. Selected Examples of Methods of Orthodontically Treating a Patient's Teeth

In various embodiments, a method of orthodontically treating a patient's teeth can comprise moving the patient's teeth from original positions in which the teeth are misaligned and/or maloccluded towards final positions in which the alignment and/or occlusion of the teeth are improved. Accordingly, such a method can comprise securing an orthodontic appliance to the patient's teeth such that the orthodontic appliance applies forces to and moves the teeth. Such an orthodontic appliance can comprise any of the appliances disclosed herein (e.g., appliance 100, etc.) and/or any other suitable orthodontic appliance such as, but not limited to, conventional braces, lingual braces, aligners, etc.

In some cases, it may be challenging to deform the appliance to secure the appliance to each of the securing members in the patient's mouth, and certain attachment portions of an appliance may be more challenging to secure to their respective securing members than others. For example, the connectors associated with teeth undergoing the greatest movements during treatment will likely require the greatest amount of deformation during installation, thus making it harder to secure the corresponding attachment portions. In addition, depending on the material of the appliance, the appliance may deform easier under tensile forces than under compressive forces, or vice versa. Nitinol, for instance, can deform more easily under tensile forces. Other factors can also make installation of certain attachment portions more difficult, such as the angle of the tooth and/or securing member, the amount of tooth exposed above the gum line, whether and what other attachment portions have already been secured, etc. For example, a degree of difficulty of securing the attachment portions to the securing members may progressively increase as additional attachment portions are secured and the appliance is increasingly deformed. In some cases, an attachment portion can be more difficult to secure to its respective securing member than other attachment portions if one or more regions of the appliance will collide with one or more of the patient's teeth and/or one or more other regions of the appliance while the appliance is being deformed to secure the attachment portion to the securing member.

The present technology comprises systems and methods that overcome the foregoing challenges. Aspects of the present disclosure include, for example, systems and methods for assigning a difficulty parameter to each attachment portion or a group of attachment portions and, based on the difficulty parameter, determining an order for securing the attachment portions to the securing portions on the teeth (e.g., a securing order) that overcomes the foregoing challenges. In some embodiments, determining a securing order includes systems and methods for predicting a difficulty parameter associated with securing each attachment portion to its respective securing member. For a given attachment portion, the difficulty parameter can be based, in whole or in part, on a type and/or magnitude of deformation of one or more regions of the appliance (e.g., an adjoining/adjacent region to the given attachment portion, a connector connected to the attachment portion, etc.) that will occur when securing an attachment portion to its respective securing member.

A method of assigning a difficulty parameter to an attachment portion can comprise predicting a type of deformation and/or a magnitude of deformation that a connector connected to the attachment portion must undergo to secure the attachment portion to a bracket on a corresponding tooth. For example, the method may comprise predicting if a connector connected to the attachment portion will predominantly undergo tension, compression, bending, and/or torsion when securing the attachment portion to the securing member. It can be more difficult to place a connector in compression than tension, so attachment portions connected to connectors that will be placed in compression can have a higher predicted difficulty than attachment portions connected to connectors that will be placed in tension. In various embodiments, a difficulty parameter assigned to an attachment portion can be based on a predicted magnitude of deformation that a connector connected to the attachment portion will undergo. For example, a first attachment portion connected to a first connector can have a higher difficulty parameter than a second attachment portion connected to a second connector if the first connector is predicted to undergo larger deformation than the second connector.

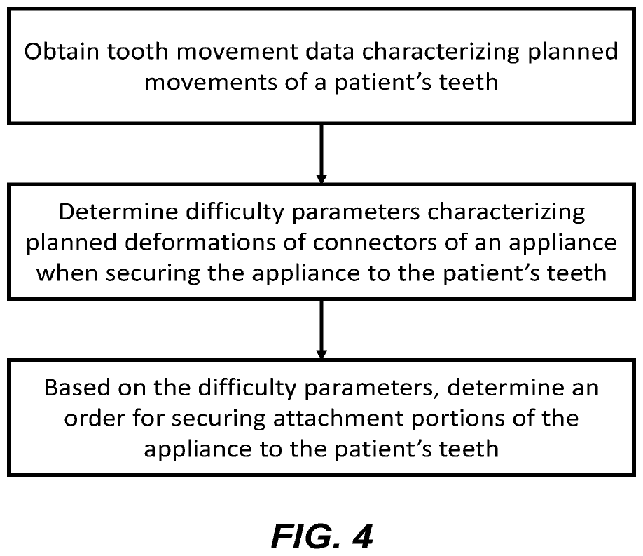

FIG. 4 is a flow chart of an example method for determining a securing order for securing attachment portions of an orthodontic appliance to a patient's teeth in accordance with several embodiments of the present technology. As shown in FIG. 4, the method can comprise obtaining tooth movement data characterizing planned movements of the patient's teeth during an orthodontic treatment. From the tooth movement data, a difficulty parameter can be determined for each connector and/or for each attachment portion that characterizes a planned deformation that a connector connected to the attachment portion will undergo when securing the attachment portion to the tooth. The method can further include determining an order for securing the attachment portions to the patient's teeth based on the difficulty parameters.

According to various embodiments, planned movements of the patient's teeth can comprise movements from an OTA to an FTA. The OTA can comprise an arrangement of the teeth when the appliance is first installed in which the teeth are misaligned and/or maloccluded. The FTA can comprise an arrangement of the teeth in which an alignment and/or occlusion of the teeth is improved. In some embodiments, the FTA comprises an arrangement in which an alignment of teeth in one of the patient's dental arches has been improved (e.g., FTA Blue). Additionally or alternatively, the FTA can comprise an overcorrected arrangement (e.g., FTA Blue+Green) in which an alignment of teeth in one of the patient's dental arches has been improved and one or more compensation parameters has been applied to the final positions of one or more teeth. In some cases, the teeth may not reach the desired final positions because of a variety of issues including relapse, insufficient force applied by the appliance, manufacturing errors, etc. Accordingly, the overcorrected arrangement can account for such issues so that the teeth at the end of treatment are located at the desired final positions, which may differ from the overcorrected final positions. In any case, the tooth movement data can comprise three translations (e.g., along an occlusogingival dimension, along a mesiodistal dimension, and/or along a buccolingual dimension) and/or three rotations (e.g., about the occlusogingival dimension, about the mesiodistal dimension, and/or about the buccolingual dimension). In some embodiments, the tooth movement data characterizes a change in distance between adjacent teeth from the OTA to the FTA.

A difficulty parameter can characterize a planned deformation that a connector connected to the attachment portion will undergo when securing the attachment portion to a respective tooth and thereby a force experienced by a user deforming the connector to secure the attachment portion. The appliance has a passive, predetermined shape in which the attachment portions are located at positions corresponding to the final positions of the teeth in the FTA. Accordingly, to install the appliance and secure the attachment portions to the patient's teeth in the OTA, the connectors of the appliance must be deformed such that the ends of the connectors are located at different positions relative to one another. The magnitude of deformation and the type of deformation of a connector are based, at least in part, on a difference between the original position of the tooth and the final position of the tooth because the connector must deform such that the attachment portion moves from the final position of the tooth to the original position of the tooth to secure the attachment portion to the tooth.

The difficulty parameter can be based, at least in part, on a planned movement of an attachment portion from the final position of the tooth to the original position of the tooth. Accordingly, the difficulty parameter can indirectly characterize a planned deformation of a connector connected to the attachment portion. Still, in some embodiments, the difficulty parameter directly characterizes the planned deformation of the connector. For example, the difficulty parameter can be based on numerical simulations which simulate deformation of the connector when moving the attachment portion from the final position of the tooth to the original position of the tooth.

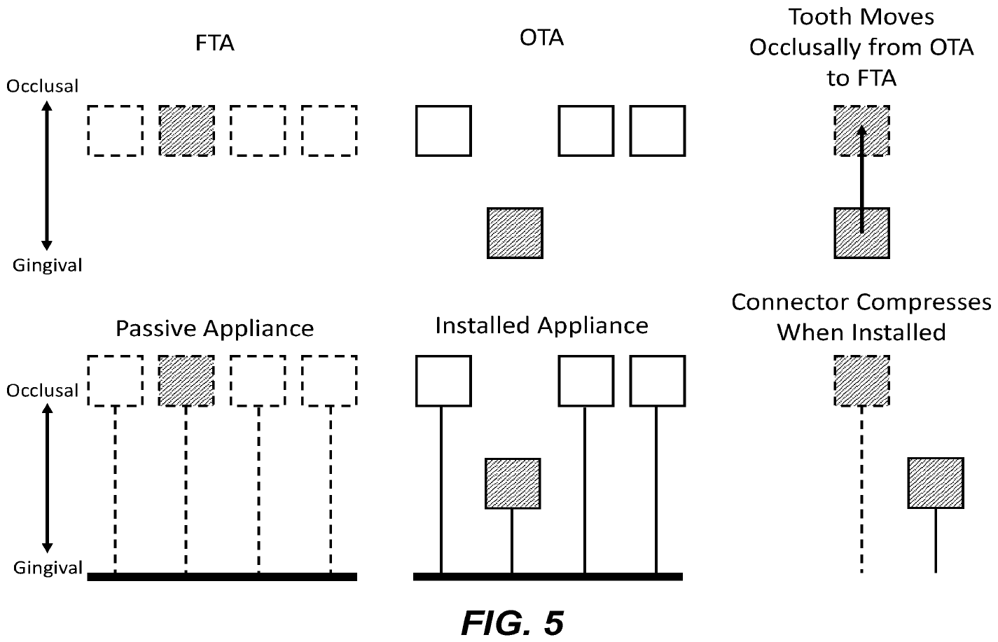

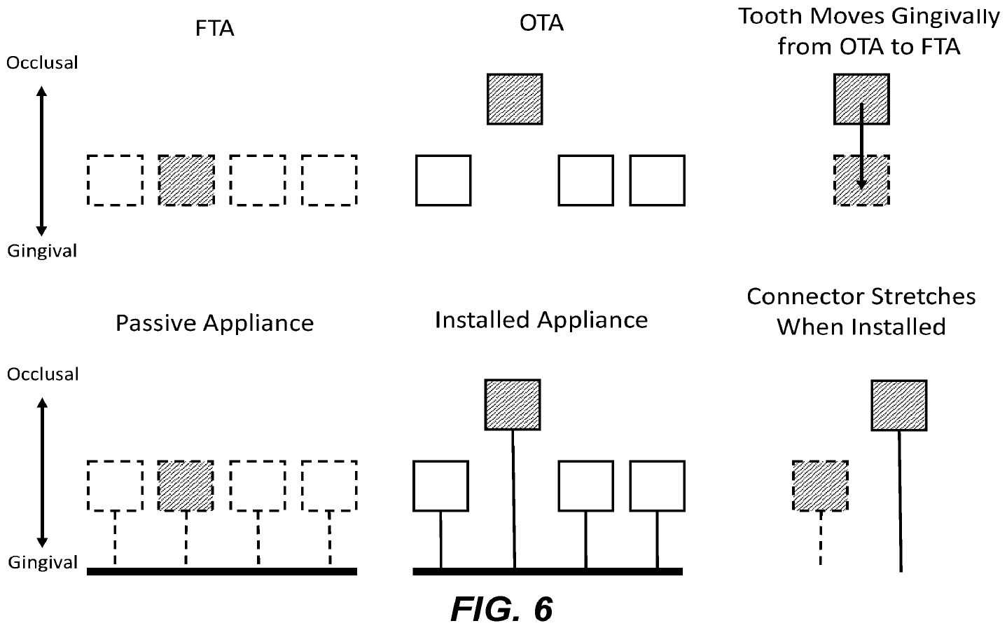

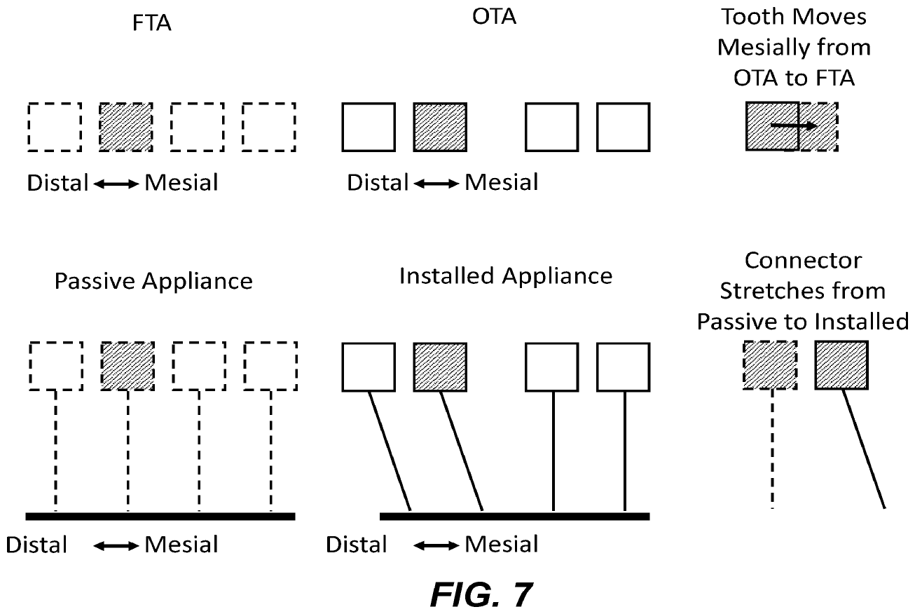

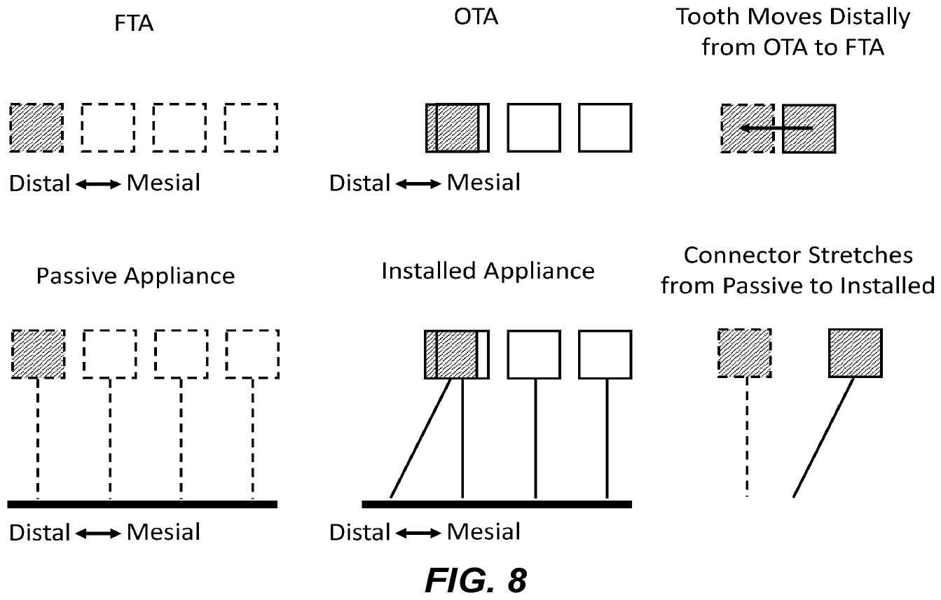

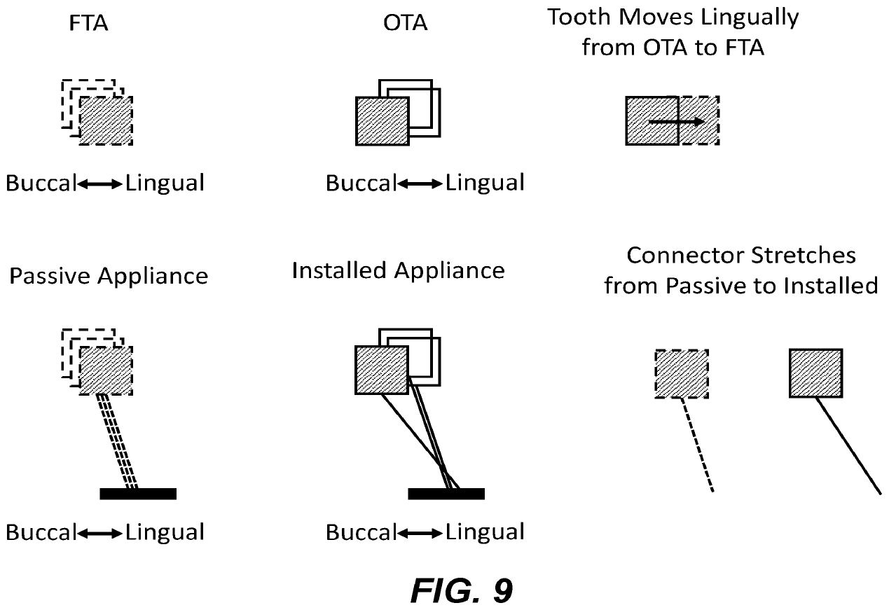

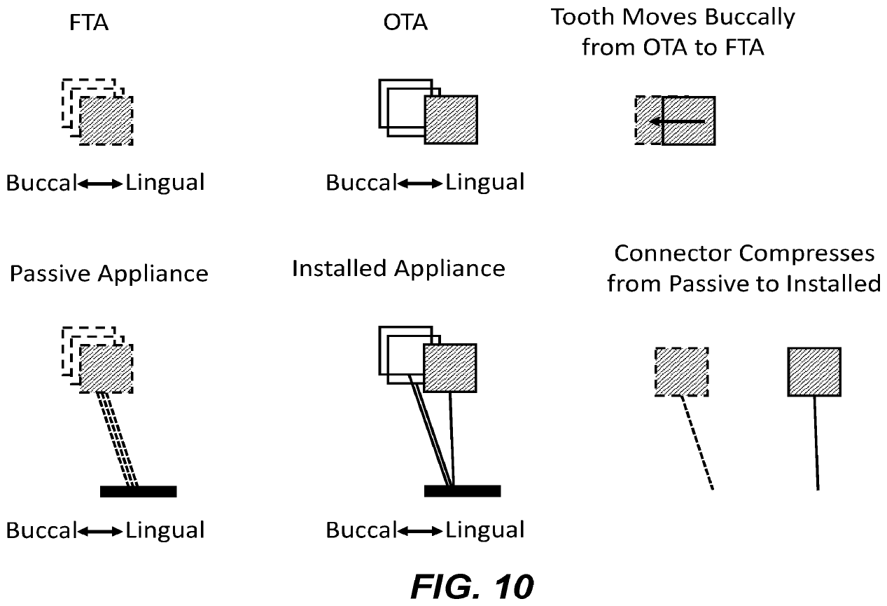

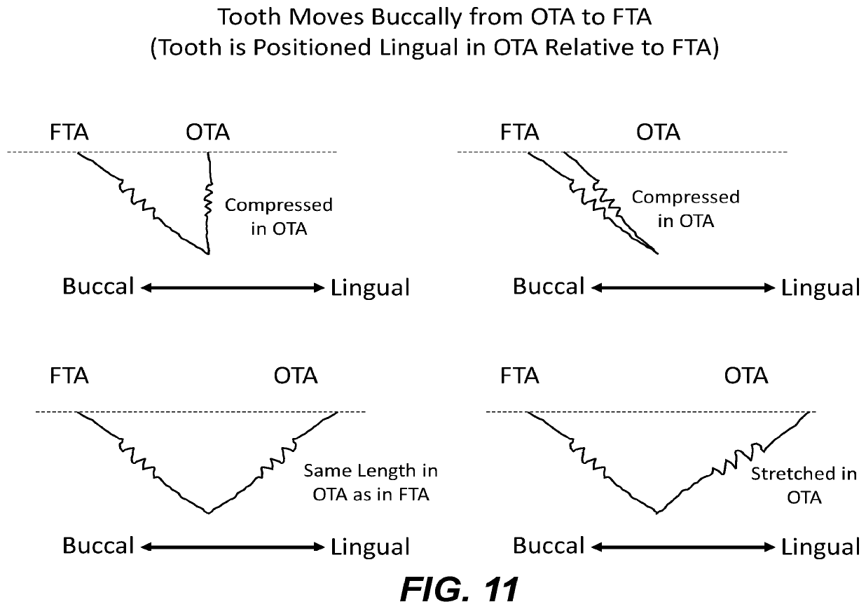

Determining a difficulty parameter can comprise using the tooth movement data to determine how much deformation a connector undergoes during installation and/or whether a connector undergoes stretching (e.g., tension, elongation, etc.) or compression along the occlusogingival dimension, the buccolingual dimension, and/or the mesiodistal dimension. FIGS. 5-11 illustrate examples of specific tooth movements along the occlusogingival dimension, the buccolingual dimension, and the mesiodistal dimension and the associated type of deformation that a connector connected to a tooth of interest will undergo. FIGS. 5 and 6 illustrate tooth movement data and planned deformation of a connector in cases in which the tooth is to be extruded during treatment and in which the tooth is to be intruded during treatment, respectively. As shown in FIG. 5, when a tooth is to be extruded during treatment (e.g., moved occlusally), the original position of the tooth is gingival of the final position of the tooth, and the connector must be compressed along the occlusogingival dimension to secure the attachment portion to the tooth in the OTA. As shown in FIG. 6, when a tooth is to be intruded during treatment (e.g., moved gingivally), the original position of the tooth is occlusal of the final position of the tooth, and the connector must be stretched along the occlusogingival dimension to secure the attachment portion to the tooth in the OTA. FIGS. 7 and 8 depict mesial and distal movement of a tooth from the OTA to the FTA, respectively. As shown in FIGS. 7 and 8, both mesial and distal tooth movement from the OTA to the FTA result in stretching of the associated connector because, in the passive state, the connector is substantially perpendicular to the mesiodistal dimension. In contrast and as shown in FIGS. 9 and 10, in a passive state the connectors of an appliance may be angled buccolingually. In some embodiments. the connectors are angled buccolingually when the appliance is configured to be positioned on a lingual side of the patient's teeth. In some embodiments, this buccolingual angle of the connectors is based on shape of an anatomy of a patient. For example, the buccolingual angle of the connectors can be based on a shape of a palate of a patient. The angle of the palate may be more pronounced for the upper jaw than the lower jaw, and so a buccolingual angle of the connectors for the upper jaw can be more pronounced than a buccolingual angle of the connectors for the lower jaw. Additionally or alternatively, the buccolingual angle of the connectors can be based on a buccolingual inclination of the teeth. Accordingly, when a tooth moves lingually from the from the OTA to the FTA (see FIG. 9), the connector is stretched when installed but when a tooth moves buccally from the from the OTA to FTA (see FIG. 10), the connector is compressed when installed. As shown in FIG. 11, whether a connector is compressed or stretched when installed in the mouth with the teeth in the OTA can depend, at least in part, on how far lingually the tooth is positioned in the OTA relative to the FTA. For example, if a tooth positioned very far lingually in the OTA relative to the FTA, a connector associated with the tooth may be stretched to reach the tooth instead of being compressed. In most cases, however, the tooth can be positioned lingually in the OTA relative to the FTA such that the connector is compressed when installed instead of stretched.

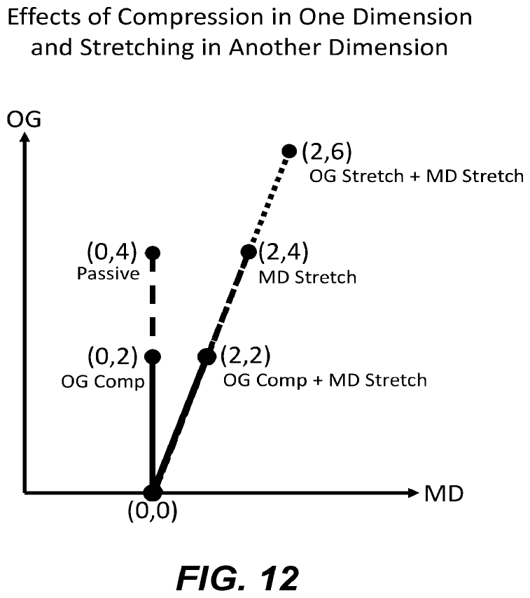

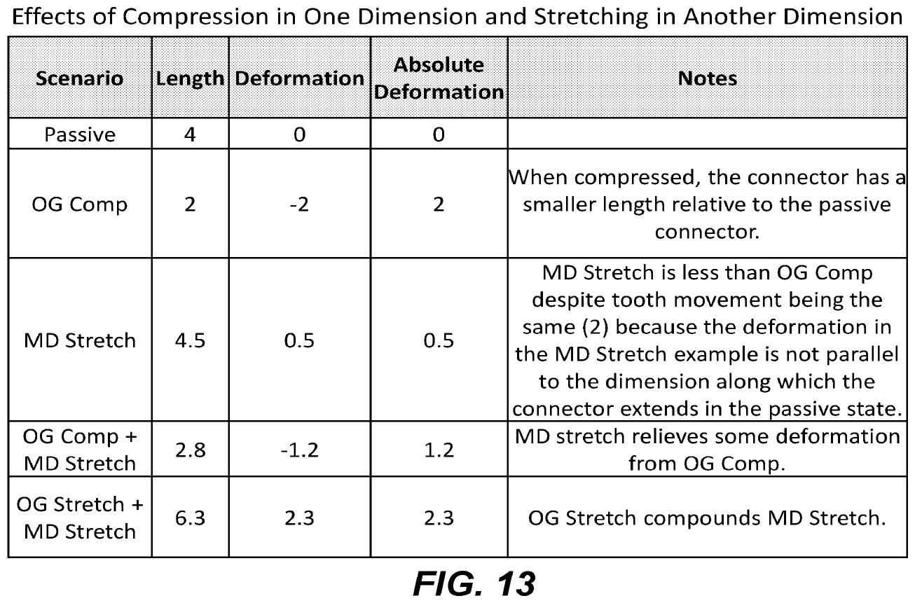

In some embodiments, a difficulty parameter for an attachment portion is based on the types and/or magnitudes of planned deformations of the connector along each of the occlusogingival dimension, the buccolingual dimension, and/or the mesiodistal dimension. However, when a connector is deformed along multiple dimensions, the deformations can interact such that the deformation is harder or easier to accomplish than a similar deformation along a single dimension. FIGS. 12 and 13 illustrate this concept. Specifically, FIG. 12 illustrates five example connectors and FIG. 13 shows a table summarizing the lengths and deformations of the example connectors. With collective reference to FIGS. 12 and 13, the first example connector is passive and extends along the occlusogingival (OG) dimension such that the connector has a length of 4. The first connector can have a first end representing a fixed end of the connector and a second end representing a position of a tooth in an FTA. The second-fifth example connectors are discussed with reference to the passive connector, and each have a fixed first end and a second end representing a position of a tooth in an OTA. The second example (OG Comp) illustrates a connector that undergoes compression along the OG dimension to be secured to a tooth in an OTA having an original position gingival of a final position of the tooth in FTA. A length of the second connector is 2 and the second connector undergoes an absolute deformation of 2 when being deformed from the passive state to the installed state. In the third example (MD Stretch), the tooth in the OTA is spaced apart from the tooth in the FTA along the mesiodistal (MD) dimension such that the third connector undergoes mesiodistal stretching when installed. In this example, the tooth is spaced apart in the OTA and FTA by 2 along the MD dimension, which is similar to the OG Comp example in which the tooth is spaced apart in the OTA and FTA by 2 along the OG dimension. However, in the MD Stretch example, the length of the third connector is only 4.5 such that expected deformation is 0.5, as compared to the expected deformation of 2 for the OG Comp connector. This is because the direction of deformation (along the MD dimension) in the MD Stretch example is not parallel to the dimension (the OG dimension) along which the third connector extends in the passive state. As shown in FIG. 12, in the fourth and fifth examples the connector undergoes deformation along the OG dimension and the MD dimension and these deformations along distinct dimensions can interact to increase or reduce the overall deformation of the connector. In the fourth example (OG Comp+MD Stretch), the tooth in the OTA is positioned gingivally by 2 and mesially or distally by 2 relative to the tooth in the FTA. Accordingly, the fourth connector undergoes compression along the OG dimension and stretching along the MD dimension such that the fourth connector undergoes an absolute deformation of 1.2, which is less than the absolute deformation of 2 with the OG Comp connector because the stretching along the MD dimension relieved some of the deformation from the compression of the fourth connector along the OG dimension. In contrast, in the fifth example (OG Stretch+MD Stretch), the fifth connector undergoes stretching along the OG dimension and the MD dimension such that the absolute deformation is 2.3, the largest absolute deformation of the five examples, because the stretching in two dimensions compound. Because of the cumulative effect of deformation along different dimensions, it may be useful for a difficulty parameter to reflect a cumulative measure of the deformations of a connector along the occlusogingival dimension, the buccolingual dimension, and the mesiodistal dimension.

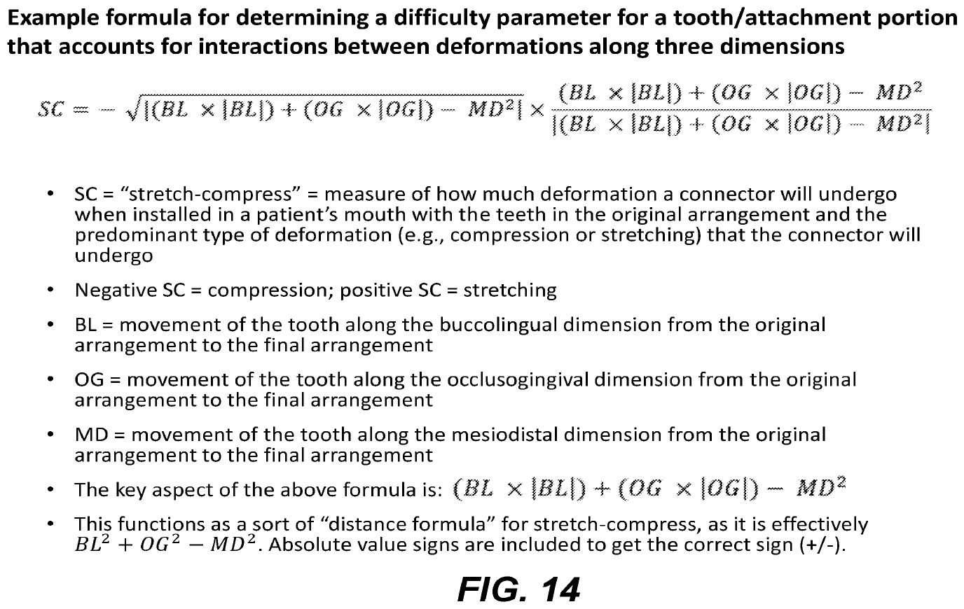

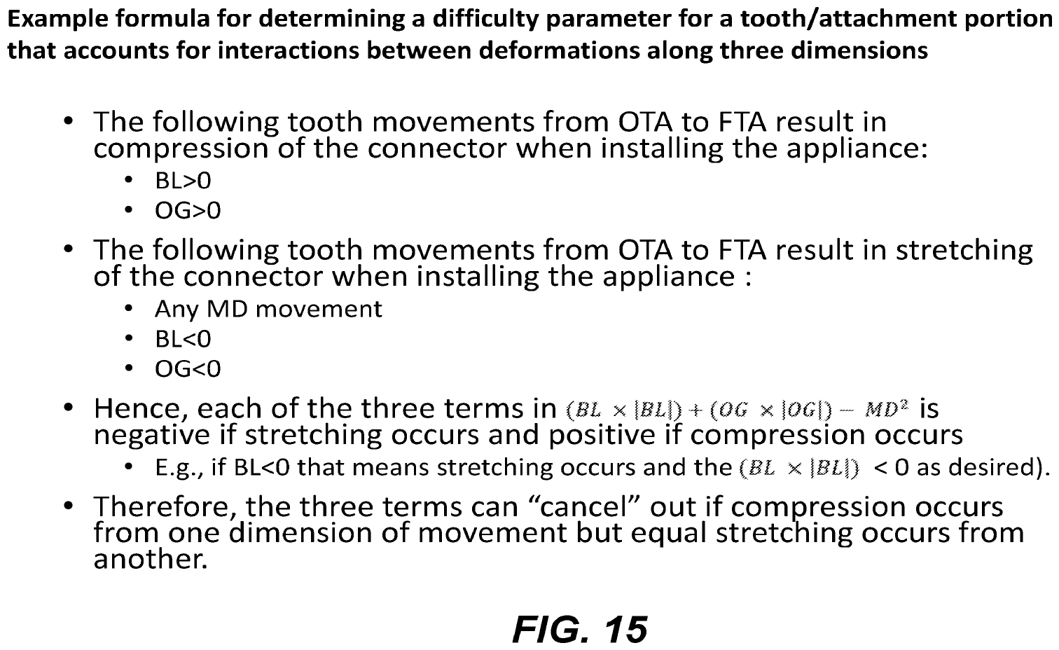

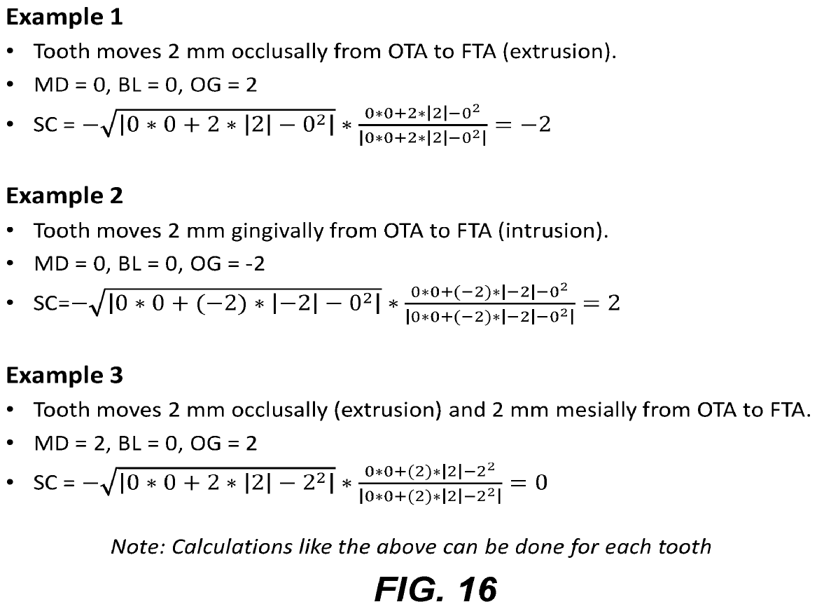

FIGS. 14 and 15 illustrate and describe an example formula for determining a difficulty parameter of a tooth and/or an associated attachment portion of an appliance based on a planned movement of the tooth from an OTA to an FTA. FIG. 16 shows example calculations using the formula from FIGS. 14 and 15. As shown in FIG. 14, the difficulty parameter can comprise a stretch-compress (SC) parameter that is a measure of how much deformation an associated connector will undergo when installed in a patient's mouth with the teeth in the OTA and the predominant type of deformation (e.g., compression or stretching) that the connector will undergo. Negative SC parameters can represent a connector that will be predominantly in compression while positive SC parameters can represent a connector that will be predominantly stretched. The inputs to the formula are BL, OG, and MD, each of which can represent a planned movement of the tooth along one dimension (the buccolingual dimension, the occlusogingival dimension, and the mesiodistal dimension, respectively) from the OTA to the FTA. In various embodiments, BL, OG, and MD represent the movement of the tooth from the OTA to an FTA in which an alignment of teeth in one of the patient's dental arches has been improved (e.g., FTA Blue). Alternatively, BL, OG, and MD represent the movement of the tooth from the OTA to an overcorrected FTA (e.g., FTA Blue+Green). In any case, the formula can function similarly to a distance formula in which the tooth movements along three dimensions are cumulatively assessed. The output of the formula is an SC parameter for the tooth and/or associated attachment portion that can be compared to the SC parameters of other teeth/attachment portions to determine which attachment portions will be the hardest to secure and should, therefore, be secured first.

Referring back to FIG. 4, a method for determining a securing order can include determining an order for securing the attachment portions to the patient's teeth based on the difficulty parameters such as the SC parameters calculated from the formula in FIG. 14. The order can comprise a continuous list in which the attachment portions are ordered according to their difficulty parameters. In some embodiments, the order comprises a list of groups of attachment portions. For example, the order can indicate that three of the attachment portions should be secured before securing another three of the attachment portions. The use of a list of groups can have certain advantages over a continuous list including, for example, ease of following the order, flexibility during installation, and others.

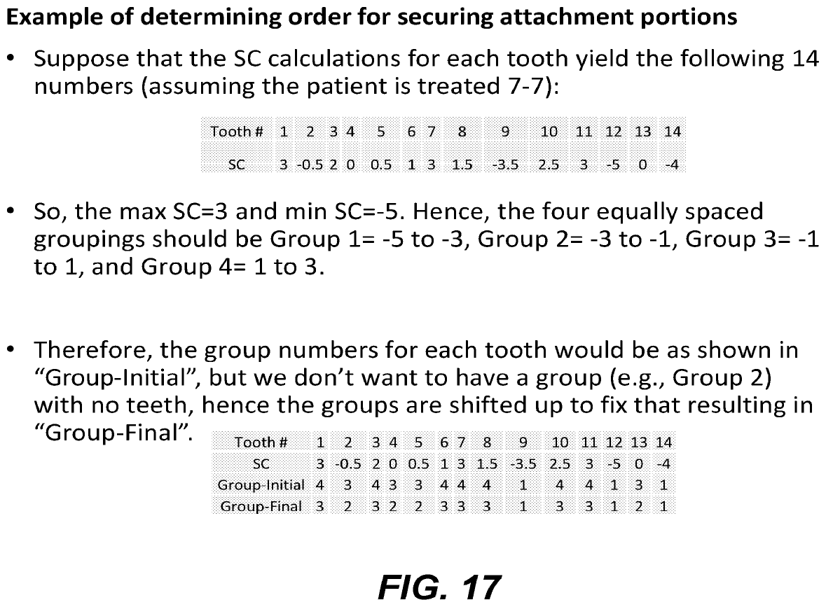

FIG. 17 illustrates an example of determining an order for securing attachment portions to a patient's teeth based on SC parameters. An SC parameter can be obtained for each tooth of a patient to be treated. As shown in FIG. 17, a maximum SC parameter and a minimum SC parameter can be identified and used to delineate one or more groups of attachment portions for the securing order. In some embodiments, the order can comprise a list of four groups of attachment portions, with the first group indicating attachment portions that should be secured first, the second group indicating attachment portions that should be secured second, the third group indicating attachment portions that should be secured third, and the fourth group indicating attachment portions that should be secured fourth. Still, any suitable number of groups (e.g., 1group, 2 groups, 3 groups, 4 groups, 5 groups, 6 groups, 7 groups, etc.) and/or a continuous list are within the scope of the present technology. The groups can be evenly spaced to span a consistent range of SC scores and/or can be delineated to include a predetermined number of teeth. In some embodiments, for example as shown in FIG. 17, the groups can be evenly spaced based on the maximum SC and the minimum SC. The teeth can be sorted into the groups based on the SC parameter of each tooth. If a group has no teeth after the sorting, the groups can be modified so that each group has at least one tooth (e.g., by modifying the limits of each group, by eliminating the empty group, etc.).

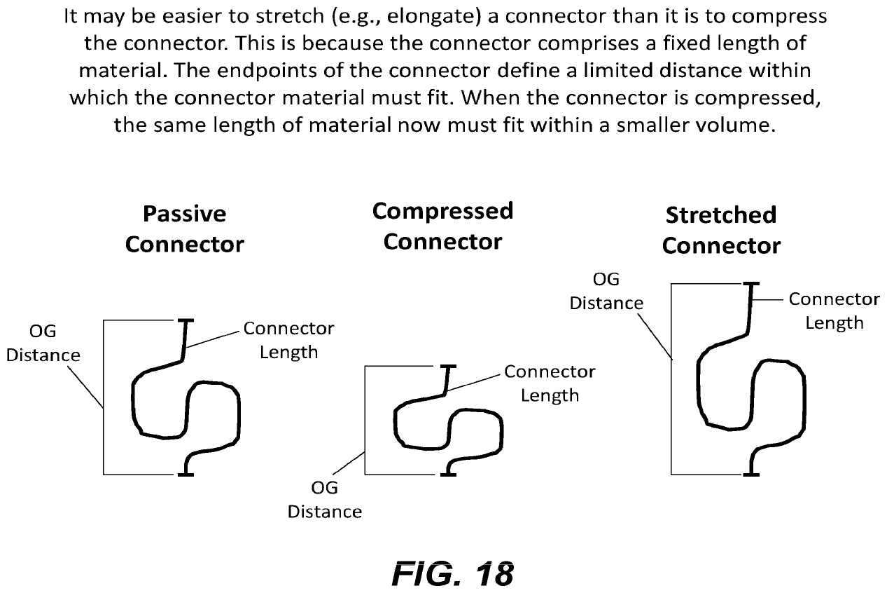

As shown in FIG. 17, the teeth are sorted so that those teeth with a large, negative SC parameter (e.g., teeth associated with connectors undergoing large compression during installation) are in the first group and should be installed first. The second group, which should be installed after the first group but before the third group, includes teeth associated with connectors undergoing smaller compression during installation. The third and fourth groups include teeth associated with connectors undergoing stretching. The teeth are sorted in this manner because, as shown and described in FIG. 18, it can be easier to stretch a connector than to compress a connector. The connector has a fixed length of material that must fit between the endpoints of the connector. As a result, more stress accumulates in the connector when the length of material is forced to fit within a smaller distance and the spring applies a greater force to the object deforming it, making it more difficult to secure the attachment portion to the tooth. Accordingly, the order can indicate that those teeth with a negative SC parameter (e.g., associated with a connector undergoing compression) should be secured earlier than those teeth with a positive SC parameter (e.g., associated with a connector undergoing tension).

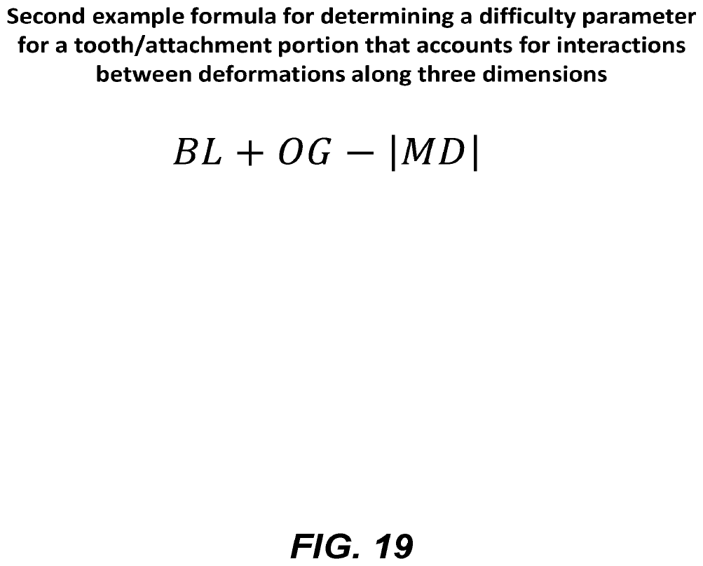

As shown in FIGS. 19-21, the present technology comprises additional methods of determining difficulty parameters and/or a securing order. For example, the planned movements of a tooth from an OTA to an FTA along the occlusogingival dimension, the buccolingual dimension, and the mesiodistal dimension can be summed and/or subtracted to determine a difficulty parameter (see FIG. 19). The use of addition or subtraction and the use of absolute values can be implemented to distinguish between multiple types of deformation (e.g., compression vs. stretching, etc.).

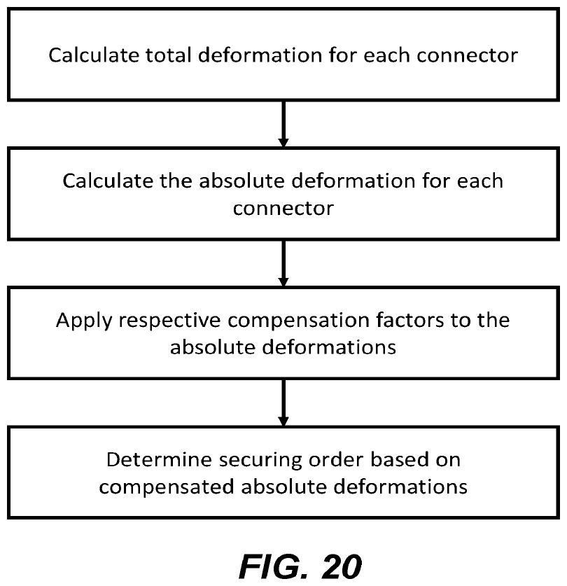

As shown in FIG. 20, a method for determining a securing order can comprise calculating a planned deformation of each connector in an appliance, calculating the absolute value of the deformation for each connector, applying compensation factors to the absolute deformations, and determining a securing order based on the compensated absolute deformations. The compensation factors can weight different types of deformation greater than others. For example, the securing order shown in FIG. 17 categorizes any negative SC parameter (compression) as more difficult than any positive SC parameter (tension). However, it may practically be more difficult to stretch a connector a large amount than to compress a connector a small amount. The approach shown in FIG. 20 can address this issue by applying appropriate compensation factors to the connectors. For example, the absolute deformation of a connector that will undergo compression can be multiplied by a compensation factor to reflect the increased difficulty of compressing the connector relative to stretching. However, if a connector will undergo large stretching, the compensated compression may still be smaller than the absolute deformation of the large stretching and the securing order can indicate that the attachment portion associated with the connector that will undergo the large stretching should be secured to the tooth before securing the attachment portion associated with the connector that will undergo the compression.

Compensation factors can be applied to the absolute deformations based on factors not related to the type of deformation a connector will undergo. For example, a compensation factor can be at least partially based on one or more parameters of a securing member that the attachment portion is configured to be secured to. In various embodiments, different teeth can carry different securing members that can secure to attachment portions with varying levels of difficulty due to different securing mechanisms (e.g., ties, clips, clamps, etc.), different sizes (e.g., narrower, wider, larger base portion, etc.), different materials, and/or other parameters. Such variable difficulty can be reflected in compensation parameters applied to the attachment portions/teeth.

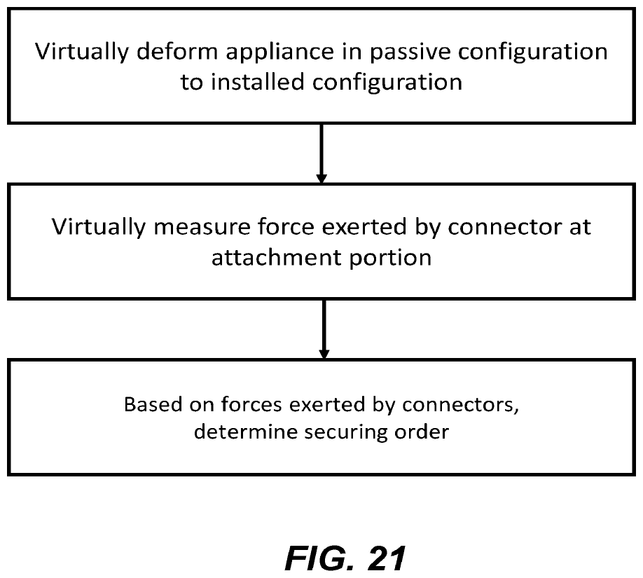

FIG. 21 depicts another method for determining a securing order using numerical simulation. The method can comprise virtually deforming a digital model of an appliance from its passive configuration to its installed configuration such that the attachment portions of the digital model of the appliance are located at positions of the teeth in an OTA. Such virtual deformation can comprise performing a finite element analysis (FEA), finite difference methodology, finite volume methodology, or other numerical simulation with a digital model of the appliance in the passive configuration. From the virtual deformation, forces exerted by each connector at its respective attachment portion can be virtually measured to assess how difficult it will be to deform the connector and secure the attachment portion to the tooth. Specifically, connectors with larger forces can be more difficult to deform during installation than connectors with smaller forces. Such virtual deformation can account for the shape, geometry, and material properties of the connectors, as well as the boundary conditions (e.g., the endpoints). A securing order can be determined based on these forces measured from the virtual deformation.

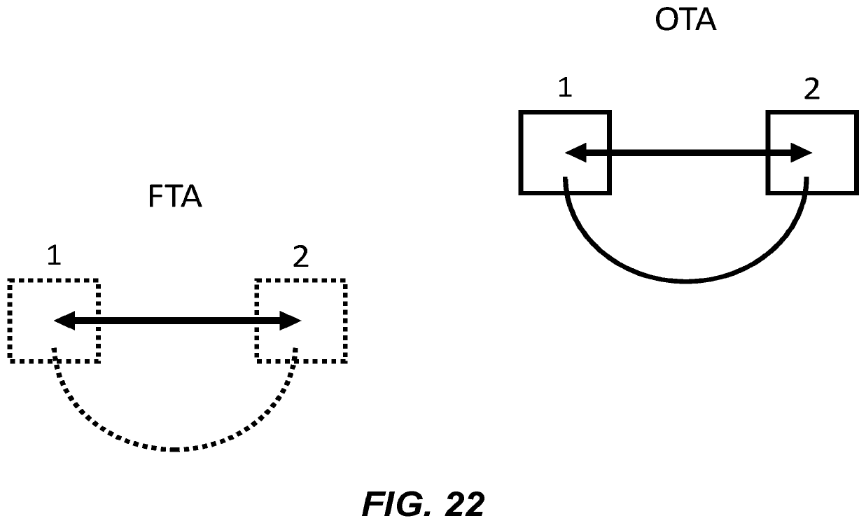

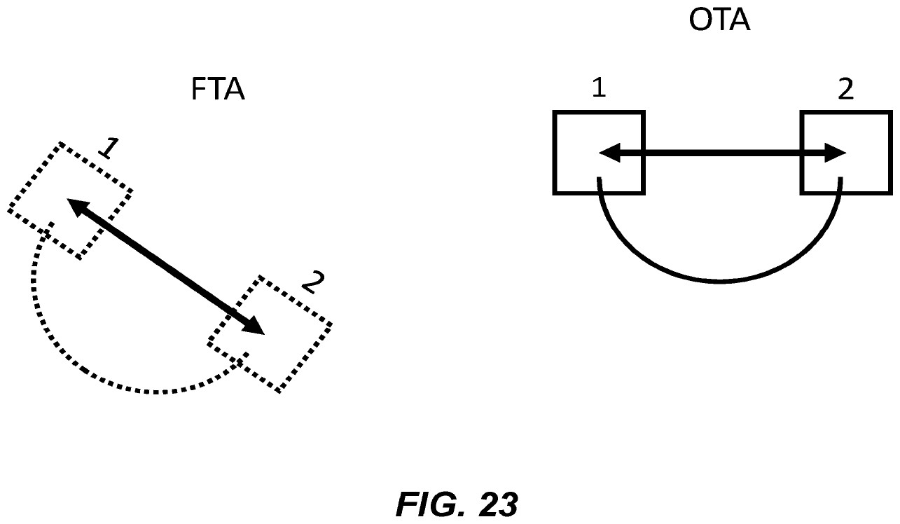

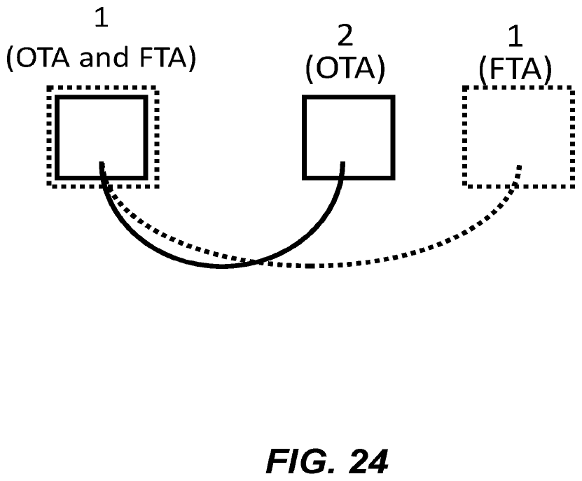

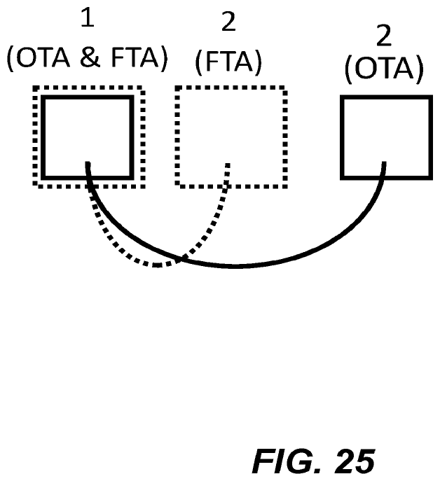

The examples shown in FIGS. 5-11 illustrate examples in which each connector has a fixed first end (e.g., connected to an anchor/third connector, etc.) and a second end comprising an attachment portion configured to be secured to a tooth. However, in some cases a connector can have first and second ends comprising attachment portions such that each end of the connector is configured to be secured to a tooth and the connector extends between two teeth instead of between one tooth and an anchor. FIGS. 22-28 illustrate examples of such connectors. In these embodiments, it can be useful to evaluate a difference in position between a pair of teeth from the OTA to the FTA rather than evaluating a difference in position of a single tooth from the OTA to the FTA. For example, in FIGS. 22 and 23, a first tooth and a second tooth both move from the OTA to the FTA. However, a distance between the first and second teeth does not change between the OTA and the FTA, so the connector does not deform when installing the appliance. In contrast, FIGS. 24 and 25 illustrate scenarios in which the connector does deform during installation. In FIG. 24, the second tooth is further from the first tooth in the FTA than in the OTA, so the connector is compressed to install the appliance. In FIG. 25, the second tooth is closer to the first tooth in the FTA than in the OTA, so the connector is stretched to install the appliance.

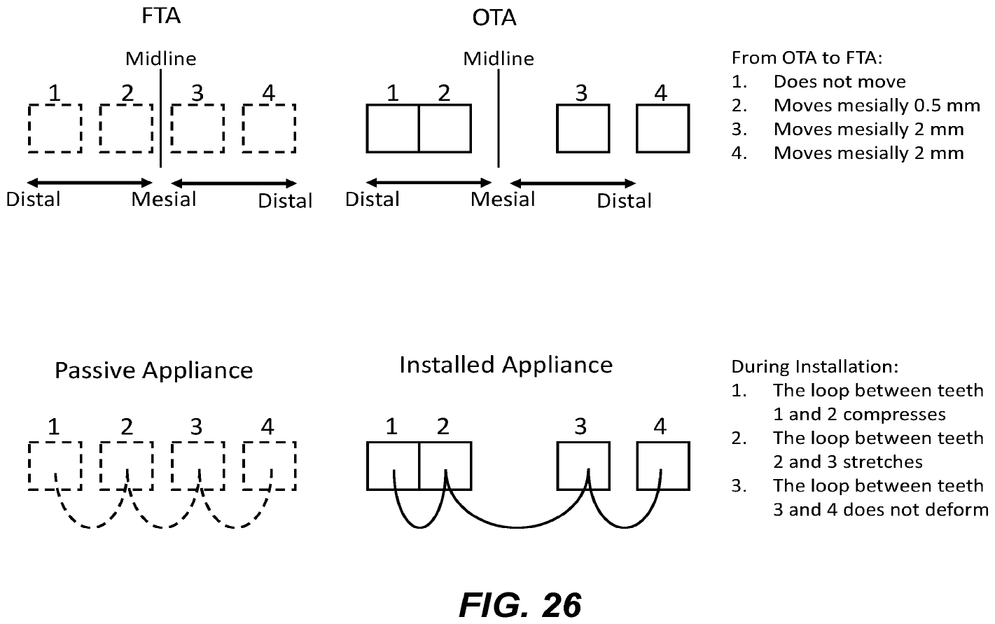

FIG. 26 depicts an example in which each of the second-fourth teeth moves mesially from the OTA and the FTA. Specifically, the second tooth moves away from the first tooth and the third and fourth teeth move towards the second tooth. Because a distance between the first and second teeth is smaller in the OTA than in the FTA, the connector extending between these teeth is compressed during installation. Conversely, a distance between the second and third teeth is larger in the OTA than in the FTA, so the connector extending between these teeth is stretched during installation. Both the third tooth and the fourth tooth move from the OTA to the FTA and the third and fourth teeth move in the same direction by the same distance so that a distance between the third and fourth teeth remains constant and a connector extending between the third and fourth teeth does not deform during installation.

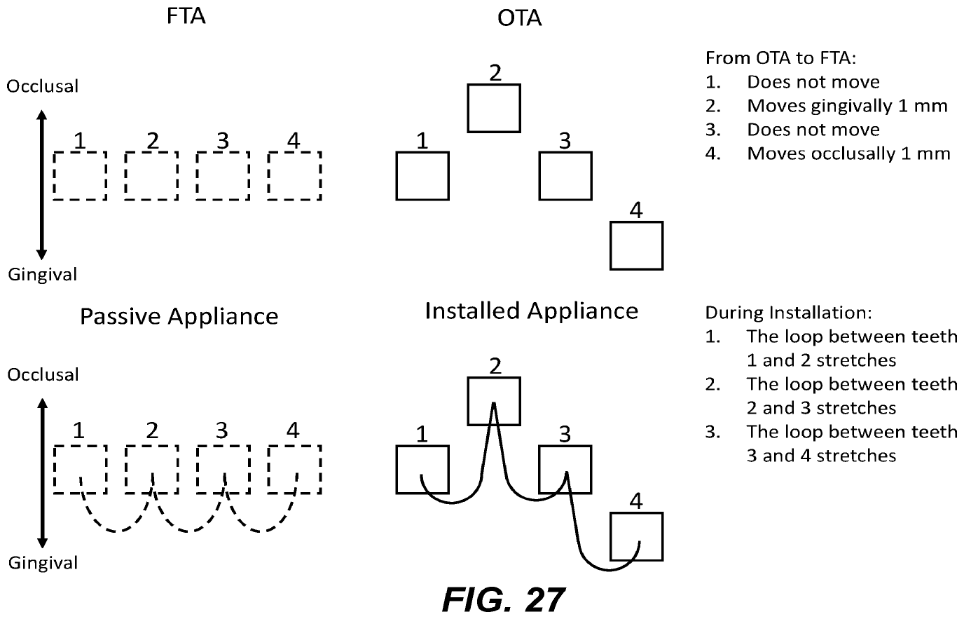

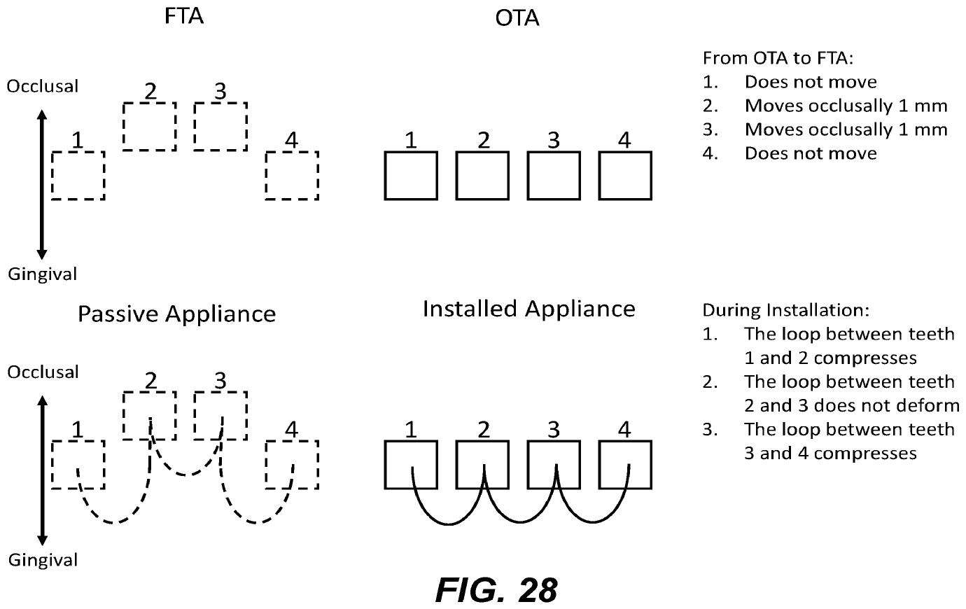

FIGS. 27 and 28 illustrate examples in which connectors can be stretched and compressed, respectively, along the occlusogingival dimension when installing the appliance. In FIG. 27, the second and fourth teeth move towards the first and third teeth from the OTA to the FTA so the connectors between the first and second teeth, the second and third teeth, and the third and fourth teeth are each stretched during installation of the appliance. Conversely, FIG. 28 illustrates an example in which the second and third teeth move away from the first and fourth teeth from the OTA to the FTA such that the connectors between the first and second teeth and the third and fourth teeth are compressed during installation of the appliance. Scenarios like those shown in FIG. 28 (e.g., moving the teeth away from one another along the occlusogingival dimension) may be less likely to occur than the scenario shown in FIG. 27 (e.g., moving the teeth towards one another along the occlusogingival dimension). While a buccolingual example is not shown for connectors extending between two teeth, the principles can be similar to those of the occlusogingival examples.

Various aspects of the present technology relate to instructions for securing an orthodontic appliance to the patient's teeth can according to specific instructions. The instructions can be carried by a tangible article such as one or more pieces of paper, a card, a book, a display screen of a computer and/or a mobile device, etc. The instructions can specify any useful information for enhancing an efficiency of treatment, an accuracy of treatment, an ease and/or efficiency of installation of an appliance into a patient's mouth, a degree of comfort of the patient during installation of the appliance and/or the orthodontic treatment, etc.

As but one example, the instructions can specify an order for securing attachment portions of an appliance to respective securing members carried by the patient's teeth, which can facilitate installation of the appliance into the patient's mouth. As described herein with reference to appliance 100, for example, installing an appliance into a patient's mouth can comprise deforming the appliance from an “as designed” configuration to a deformed configuration to secure the appliance to the securing members. The appliance can then impart a continuous, corrective force on the teeth to move the teeth towards final positions in which the appliance resumes its “as-designed” configuration.

To facilitate securing of an appliance to a patient's teeth, instructions in accordance with the present technology can specify an order for securing attachment portions of the appliance to securing members carried by the patient's teeth. Accordingly, various embodiments of the present technology are directed to methods of obtaining an order for securing a plurality of attachment portions to a plurality of securing members.

The order can comprise a timeline for securing each attachment portion to its respective securing member relative to the other attachment portions. Each attachment portion can be assigned a unique difficulty parameter and/or a group difficulty parameter. For example, the attachment portions can be sorted into groups and the order can comprise a relative timeline for securing each group of attachment portions. For example, the order can indicate that attachment portions that are associated with a higher difficulty of securing should be secured to their respective securing members before the other attachment portions. In some embodiments, the predetermined order can be based on other parameters besides or in addition to the difficulty associated with securing each attachment portion to its respective securing member. In various embodiments, the predetermined order can be determined from one or more rules. In some embodiments, a method of determining a predetermined order can comprise determining whether any of the patient's teeth have specific original positions and, based on this determination, assigning a specific and/or relative timing for the attachment portion to be secured relative to the other attachment portions. For example, the predetermined order can indicate that an attachment portion associated with a tooth that has an original position that is substantially lingual and gingival (or has buccal root torque, lingual crown torque, etc.) should be secured first. In some cases, the predetermined order can include a relative order for securing the attachment portions to their securing members and/or a predetermined time between securing two or more sequential attachment portions. For example, it may be helpful to secure only some of the attachment portions to their respective securing members at a first timepoint and delay securing the remaining attachment portion(s) to their respective securing members until a later time. The appliance can move the teeth secured to the appliance via the secured attachment portions, which can facilitate securing the remaining attachment portions to their respective securing members (e.g., by expanding the arch, by rotating a tooth, etc.).

Various embodiments of the present technology comprise devices, systems, and methods for communicating instructions for orthodontically treating a patient's teeth to an operator. In some embodiments, a method for communicating such instructions comprises displaying instructions on a display screen of a computing device, such as a personal computer and/or a mobile device, for example via a graphical user interface. In some embodiments, the graphical user interface can display a graphical representation of the patient's teeth and/or a graphical representation of the instructions. In various embodiments, a user can toggle between different views. The different views can comprise, for example, only the graphical representation of the patient's teeth, only the graphical representation of the instructions, and/or both the graphical representation of the patient's teeth and the graphical representation of the instructions. Additionally or alternatively, a method for communicating such instructions can comprise providing the instructions to the operator on a physical article, such as a card, leaflet, or other tangible form. In some embodiments, a packaging of an orthodontic appliance can comprise the instructions.

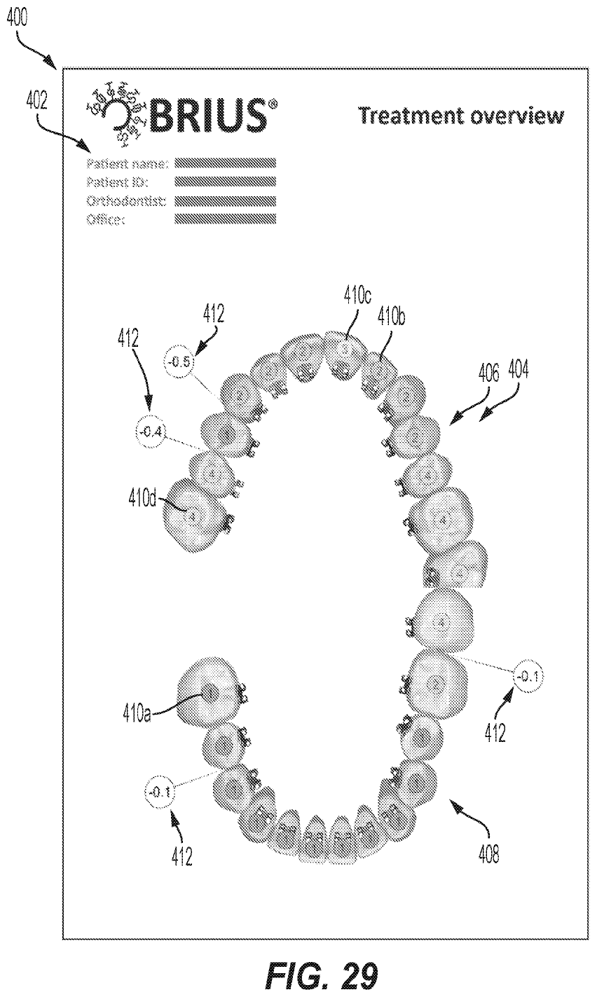

FIG. 29 depicts an example of instructions 400 for orthodontically treating a patient's teeth. The instructions 400 can have similar features as any of the instructions disclosed herein. As shown in FIG. 29, the instructions can comprise bibliographic information 402 identifying a patient associated with the instructions 400, identifying an orthodontist associated with the instructions 400, identifying an orthodontic office associated with the instructions 400, etc. In various embodiments, the instructions 400 can comprise a predetermined order 404 for securing attachment portions of an appliance to a patient's teeth. For example, as shown in FIG. 29, the instructions 400 can comprise an illustration of the teeth of the patient's upper jaw 406 and/or an illustration of the teeth of the patient's lower jaw 408. The instructions 400 can comprise indicia 410 indicating the order 404. In some embodiments the indicia 410 comprises one or more numbers, letters, symbols, colors, patterns, shapes, etc. For example, as shown in FIG. 29, the indicia 410 can comprise first indicia 410a comprising a first number (e.g., the ‘1’ indicia shown, etc.), a first shape (e.g., a circle, etc.), and/or a first color (e.g., red, etc.), second indicia 410b comprising a second number (e.g., the ‘2’ indicia shown, etc.), a second shape (e.g., a circle, etc.), and/or a second color (e.g., orange, etc.), a third indicia 410c comprising a third number (e.g., the ‘3’ indicia shown, etc.), a third shape (e.g., a circle, etc.), and/or a third color (e.g., yellow, etc.), and/or fourth indicia 410d comprising a fourth number (e.g., the ‘4’ indicia shown, etc.), a fourth shape (e.g., a circle, etc.), and/or a fourth color (e.g., green, etc.). The first-fourth numbers can be configured to communicate a relative timeline for securing the attachment portions associated with the teeth that are associated with each number. For example, the instructions 400 can be configured to communicate that teeth associated with the first indicia 410a comprising the number ‘1’, should be secured to their respective securing members before teeth associated with second indicia 410b comprising the number ‘2’, teeth associated with the second indicia 410b should be secured to their respective securing members before teeth associated with the third indicia 410c comprising the number ‘3’, etc. In some embodiments, the shape, color, pattern, etc. of the indicia 410 can be configured communicate the order for securing attachment portions to their respective members. Additionally or alternatively, the shape, color, pattern, etc. of the indicia 410 may not be configured communicate any unique information about the tooth to which is associated (e.g., the circular shape of the indicia may not encode any unique information about the instructions for securing the attachment portions and may instead be aesthetic, etc.).

In some embodiments, the instructions 400 comprise information about auxiliary orthodontic treatments and/or interventions. For example, as shown in FIG. 29, the instructions 400 can comprise a prescription for interproximal reduction 412 that is to be performed between adjacent teeth of the patient. In some embodiments, the instructions 400 include indicia configured to identify an interproximal space for treatment and/or an amount of enamel to remove from one or more teeth adjacent an interproximal space.

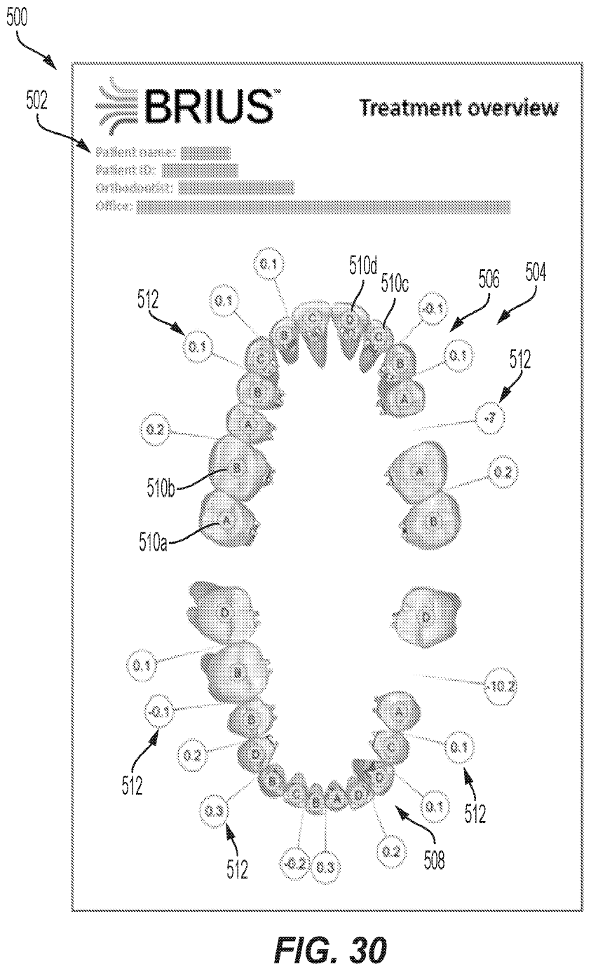

FIG. 30 depicts an example of instructions 500 for orthodontically treating a patient's teeth. The instructions 500 can have similar features as any of the instructions disclosed herein. As shown in FIG. 30, the instructions can comprise bibliographic information 502 identifying a patient associated with the instructions 500, identifying an orthodontist associated with the instructions 500, identifying an orthodontic office associated with the instructions 500, etc. In various embodiments, the instructions 500 can comprise an order 504 for securing attachment portions of an appliance to a patient's teeth. For example, as shown in FIG. 30, the instructions 500 can comprise an illustration of the teeth of the patient's upper jaw 506 and/or an illustration of the teeth of the patient's lower jaw 508. The instructions 500 can comprise indicia 510 indicating the order 504. In some embodiments the indicia 510 comprises one or more numbers, letters, symbols, colors, patterns, shapes, etc. For example, as shown in FIG. 30, the indicia 510 can comprise first indicia 510a comprising a first letter (e.g., the ‘A’ indicia shown, etc.), second indicia 510b comprising a second letter (e.g., the ‘B’ indicia shown, etc.), third indicia 510c comprising a third letter (e.g., the ‘C’ indicia shown, etc.), fourth indicia 510d comprising a fourth letter (e.g., the ‘D’ indicia shown, etc.), and/or other indicia 510. The first-fourth letters can be configured to communicate a relative timeline for securing the attachment portions associated with the teeth that are associated with each number. For example, the instructions 500 can be configured to communicate that teeth associated with the first indicia 510a comprising the letter ‘A’, should be secured to their respective securing members before teeth associated with second indicia 510b comprising the letter ‘B’, teeth associated with the second indicia 510b should be secured to their respective securing members before teeth associated with the third indicia 510c comprising the letter ‘C’, teeth associated with the third indicia 510c should be secured to their respective securing members before teeth associated with the fourth indicia 510d comprising the letter ‘D’, etc. In some embodiments, for example as shown in FIG. 30, the first indicia 510a, the second indicia 510b, the third indicia 510c, and/or the fourth indicia 510d can comprise similar shapes, colors, patterns, etc. Additionally or alternatively, the first indicia 510a, the second indicia 510b, the third indicia 510c, and/or the fourth indicia 510d can comprise similar shapes, colors, patterns, etc. can comprise a unique shape, a unique color, a unique pattern, etc.

In some embodiments, the instructions 500 comprise information about auxiliary orthodontic treatments and/or interventions. For example, as shown in FIG. 30, the instructions 500 can include space indicia 512 indicating one or more spaces between adjacent teeth. The space indicia 512 can indicate current spacing between adjacent teeth, prior spacing between adjacent teeth, and/or intended spacing between adjacent teeth. In some embodiments, the space indicia 512 comprise a prescription for interproximal reduction that is to be performed between adjacent teeth. In some embodiments, the space indicia 512 are configured to identify an interproximal space for treatment and/or an amount of enamel to remove from one or more teeth adjacent an interproximal space.

Various embodiments of the present technology comprise orthodontically treating a patient's teeth according to specific instructions, for example the instructions previously described herein. In some embodiments, a method of orthodontically treating a patient's teeth comprises obtaining the instructions. The instructions can be obtained from a graphical user interface and/or a physical article of manufacture. In some embodiments, the graphical user interface can display a graphical representation of the patient's teeth and/or a graphical representation of the instructions. In various embodiments, a user can toggle between views to view only the graphical representation of the patient's teeth, only the graphical representation of the instructions, and/or both the graphical representation of the patient's teeth and the graphical representation of the instructions. Additionally or alternatively, a method of orthodontically treating a patient's teeth can comprise obtaining an appliance for delivering orthodontic force to the patient's teeth and/or obtaining a tool for performing another orthodontic intervention (e.g., obtaining a file for performing interproximal reduction, obtaining a tool for facilitating installation of the appliance, etc.). Treating a patient's teeth according to the specific instructions can comprise securing attachment portions of an orthodontic appliance to the patient's teeth according to the instructions, which can comprise securing the attachment portions to respective securing members carried by the patient's teeth according to an order communicated by the instructions.

In some embodiments, a method of manufacturing an orthodontic appliance can comprise evaluating a predicted difficulty of securing the appliance to the patient's teeth and optionally, based on the evaluation, modifying a design of the appliance to reduce the predicted difficulty. In various embodiments, evaluating the predicted difficulty can comprise evaluating a predicted difficulty of a single attachment portion and/or evaluating a predicted difficulty of multiple attachment portions. For example, evaluating the predicted difficulty can comprise comparing a predicted difficulty of each attachment portion to a predetermined difficulty threshold and, if the predicted difficulty of one, some, or all of the attachment portions exceeds the predetermined difficulty threshold, a design of the appliance can be modified. Such a method can comprise iteratively evaluating a predicted difficulty of securing the appliance to the patient's teeth and modifying a design of the appliance based on the evaluation.

### Conclusion

Although many of the embodiments are described above primarily with respect to systems, devices, and methods for orthodontic appliances positioned on a lingual side of a patient's teeth, the technology is applicable to other applications and/or other approaches, such as orthodontic appliances positioned on a facial or buccal side of the patient's teeth. Moreover, other embodiments in addition to those described herein are within the scope of the technology. Additionally, several other embodiments of the technology can have different configurations, components, or procedures than those described herein. A person of ordinary skill in the art, therefore, will accordingly understand that the technology can have other embodiments with additional elements, or the technology can have other embodiments without several of the features shown and described above with reference to FIGS. 1A-30.

The descriptions of embodiments of the technology are not intended to be exhaustive or to limit the technology to the precise form disclosed above. Where the context permits, singular or plural terms may also include the plural or singular term, respectively. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. The various embodiments described herein may also be combined to provide further embodiments.

As used herein, the terms “generally,” “substantially,” “about,” and similar terms are used as terms of approximation and not as terms of degree, and are intended to account for the inherent variations in measured or calculated values that would be recognized by those of ordinary skill in the art.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Additionally, the term “comprising” is used throughout to mean including at least the recited feature(s) such that any greater number of the same feature and/or additional types of other features are not precluded. It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

1. A tangible, non-transitory computer-readable medium storing instructions that, when executed by the one or more processors of a computing device, cause the computing device to perform operations comprising:
determining a first deformation parameter for a first attachment portion of an orthodontic appliance, the first attachment portion carried by a first connector, wherein the first deformation parameter is indicative of a force required to deform the first connector from an as-designed configuration to an installed configuration;
determining a second deformation parameter for a second attachment portion of the orthodontic appliance, the second attachment portion carried by a second connector, wherein the second deformation parameter is indicative of a force required to deform the second connector from an as-designed configuration to an installed configuration;
determining a first difficulty score for the first attachment portion based at least in part on the first deformation parameter, wherein the first difficulty score indicates a clinician's degree of difficulty when attaching the first attachment portion to a corresponding securing member during installation of the orthodontic appliance;
determining a second difficulty score for the second attachment portion based at least in part on the second deformation parameter, wherein the second difficulty score indicates a clinician's degree of difficulty when attaching the second attachment portion to a corresponding securing member during installation of the orthodontic appliance; and
displaying the first and second difficulty scores to a user.

2. The tangible, non-transitory computer-readable medium of claim 1, wherein the first and second difficulty scores indicate a suggested order for connecting the first and second attachment portions to their respective securing members during installation of the orthodontic appliance.

3. The tangible, non-transitory computer-readable medium of claim 1, the operations further comprising comparing the first and second difficulty scores.

4. The tangible, non-transitory computer-readable medium of claim 1, wherein determining the first difficulty score comprises comparing the first deformation parameter to the second deformation parameter.

5. The tangible, non-transitory computer-readable medium of any one of claims 1 to 4, wherein the first and second difficulty scores are the same.

6. The tangible, non-transitory computer-readable medium of claim 1, wherein the first and second difficulty scores are different.

7. The tangible, non-transitory computer-readable medium of claim 1, wherein the orthodontic appliance comprises a connector configured to extend along two or more of a patient's teeth when the orthodontic appliance is installed in the patient's mouth, and wherein the first and second connectors extend occlusally away from the connector.

8. A method for assisting installation of an orthodontic appliance, the method comprising:
determining a first deformation parameter for a first attachment portion of an orthodontic appliance, the first attachment portion carried by a first connector, wherein the first deformation parameter is indicative of a force required to deform the first connector from an as-designed configuration to an installed configuration;
determining a second deformation parameter for a second attachment portion of the orthodontic appliance, the second attachment portion carried by a second connector, wherein the second deformation parameter is indicative of a force required to deform the second connector from an as-designed configuration to an installed configuration;
determining a first difficulty score for the first attachment portion based at least in part on the first deformation parameter, wherein the first difficulty score indicates a clinician's degree of difficulty when attaching the first attachment portion to a corresponding securing member during installation of the orthodontic appliance;
determining a second difficulty score for the second attachment portion based at least in part on the second deformation parameter, wherein the second difficulty score indicates a clinician's degree of difficulty when attaching the second attachment portion to a corresponding securing member during installation of the orthodontic appliance; and
displaying the first and second difficulty scores to a user.

9. The method of claim 8, wherein the first and second difficulty scores indicate a suggested order for connecting the first and second attachment portions to their respective securing members during installation of the orthodontic appliance.

10. The method of claim 8, the operations further comprising comparing the first and second difficulty scores.

11. The method of claim 8, wherein determining the first difficulty score comprises comparing the first deformation parameter to the second deformation parameter.

12. The method of claim 8, wherein the first and second difficulty scores are the same.

13. The method of claim 8, wherein the first and second difficulty scores are different.

14. The method of claim 8, wherein the orthodontic appliance comprises a connector configured to extend along two or more of a patient's teeth when the orthodontic appliance is installed in the patient's mouth, and wherein the first and second connectors extend occlusally away from the connector.

15. The method of claim 8, wherein the orthodontic appliance is configured to move the teeth from original positions to different, final positions.
